(19) United States
(12) Patent Application Publication
(10) Pub. No.: US 2023/0099324 A1
(43) Pub. Date: Mar. 30, 2023

(54) ESTABLISHING NEW CONNECTIONS IN A COMMUNICATION PLATFORM

(71) Applicant: Slack Technologies, LLC, San Francisco, CA (US)

(72) Inventors: Matthew Wahl, San Francisco, CA (US); Elizabeth Clemenson, San Francisco, CA (US); Anna Kalkanis, Berkeley, CA (US); Erin Woo, Alameda, CA (US); Tatiana Petkova, San Francisco, CA (US); Derek Hollis, San Francisco, CA (US)

(21) Appl. No.: 17/484,824

(22) Filed: Sep. 24, 2021

(51) Int. Cl. H04L 12/58; G06F 3/0484; H04L 29/08

(52) U.S. Cl. CPC H04L 51/22; G06F 3/04842; H04L 67/306

(57) ABSTRACT

Techniques for enabling contact sharing via communications transmitted via a communication platform are described herein. In an example, a first user can communicate with a second user via a virtual space (e.g., direct messaging instance, communication channel, etc.) of the communication platform. The first user can include an indicator associated with a third user in a communication to be transmitted via the virtual space. In response to a determination that the second user and the third user have not previously established a connection, the communication platform can associate a contact card of the third user with the communication. The contact card can include contact information associated with the third user. The contact card can be selectable to enable communications between the second user and the third user and/or to add the contact information associated with the third user to a contact list of the second user.

### TECHNICAL FIELD

Communication platforms are becoming increasingly more popular for facilitating communications between two or more people, such as to collaborate on a project, plan an event, or the like. A user of a communication platform may communicate with other users of the communication platform, such as with other users with whom the user has established a connection. Additional users of the communication platform, however, may be unavailable for communications unless another user that has a common connection establishes a multi-party direct message or other connection with the user. For example, a first user and a second user may be in a conversation, and the first user determines that they want to connect the second user and the third user for collaboration on a separate project. The first user can then generate a multi-party direct message to introduce the second and third users, such as to enable a connection. However, generating a multi-party direct message to introduce one user to another can be cumbersome and unwieldy, and can lead to a cluttered interface of multiple, potentially unused, instances of multi-party direct messages.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different figures indicates similar or identical components or features.

FIG. 1 is a block diagram illustrating an example system of computing devices usable to implement example techniques described herein.

FIG. 2 is a schematic view of an example user interface associated with a communication platform through which a user can access contact information associated with another user via a contact card, utilizing the techniques described herein.

FIG. 3A illustrates an example process for presenting a contact card associated with a user in association with a communication, utilizing the techniques described herein.

FIG. 3B illustrates an example process for enabling communications via a contact card presented in association with a communication that is transmitted via the communication platform, utilizing the techniques described herein.

FIGS. 4A-4C illustrate example user interfaces associated with sharing contact information of a user with another user and providing an introductory communication to be presented in association with a virtual space between the user and the other user, utilizing the techniques described herein.

FIG. 5 illustrates an example process for updating a contact list of a user based on a selection of a contact card associated with another user that is transmitted via a communication platform, utilizing the techniques described herein.

FIGS. 6A-6C illustrate example user interfaces associated with receiving an invitation to connect via the communication platform and generating a virtual space in response to an acceptance thereof, utilizing the techniques described herein.

FIG. 7 illustrates an example user interface associated with establishing user preferences associated with enabling contact information sharing, utilizing the techniques described herein.

FIG. 8 illustrates an example process for enabling communications between two previously unconnected users via a contact card shared by a third user, utilizing the techniques described herein.

FIG. 9 illustrates an example process for establishing communications between two previously unconnected users in response to receiving an indication of selection of an option to communicate, utilizing the techniques described herein.

FIG. 10 illustrates an example process for disabling communications via a contact card in response to receiving a request to block the communications, utilizing the techniques described herein.

FIG. 11 illustrates an example process for determining whether to cause a presentation of a contact card of a first user in association with a communication between a second user and a third user, utilizing the techniques described herein.

FIG. 12 illustrates an example process for storing contact information associated with a contact card in a contact list of a user, utilizing the techniques described herein.

### DETAILED DESCRIPTION

Techniques for enabling contact sharing via communications transmitted via a communication platform are described herein. The communication platform can be a group-based communication platform, a channel-based messaging platform, and/or any other platform for facilitating communication between and among users. In an example, a first user can communicate with a second user via a virtual space (e.g., direct messaging instance, communication channel, etc.) of the communication platform. The first user can include an indicator associated with a third user of the communication platform in a communication to be transmitted via the virtual space. In response to a determination that the second user and the third user are associated with different organizations, the communication platform can associate a contact card of the third user with the communication. The contact card can include contact information associated with the third user. In at least one example, the contact card can be selectable to enable communications between the second user and the third user. In some examples, the contact card can be selectable to add the contact information associated with the third user to a contact list of the second user.

In existing technologies, a first user can introduce a second user to a third user by generating a multi-party direct messaging instance between the first, the second, and the third party. The first user can invite both the second user and the third user to join the multi-party direct messaging instance. However, if one or both of the second user and the third user do not respond to the invitation to communicate, the first user may be unable to broker the connection between the second user and the third user. In such scenarios, the first user can identify an email address or other contact information associated with the third user to provide to the second user. The second user can then send an invitation to the third user to communicate via the communication channel and/or an alternate means of communication (e.g., email, telephone, etc.). However, the third user may not recognize the second user, and without any indication of the first user brokering the connection, may reject the invitation to connect. In some examples, the third user may consider the invitation (without the indication of the first user brokering the connection) as an unwanted communication and may block the second user from communicating with the third user via the communication platform.

In examples in which the second user and the third user join the multi-party direct messaging instance generated by the first user, the first user can provide an introduction and initiate a conversation between the second user and the third user. However, further communications in the multi-party direct messaging instance between the second user and the third user may not be relevant to the first user, and may clutter an interface associated with the first user with undesirable indicators and notifications. Additionally, if the first user brokers a plurality of connections via a plurality of multi-party direct messaging instances, the interface associated with the first user may become unwieldy and difficult to manage.

Techniques described herein are directed to providing an efficient means by which a first user can broker connections between other previously unconnected users of the communication platform. In at least one example, a first user of the communication platform can communicate with at least a second user of the communication platform via a virtual space. In at least one example, the virtual space can include a direct messaging instance (“DM” instance). In some examples, the virtual space can include a communication channel, a thread associated with a communication channel, a workspace, a board, and/or other spaces that enable written communications between parties. The first user and the second user (and/or other users included in the virtual space) can compose and transmit messages (e.g., communications) to each other via the virtual space. The messages can include text, as well as files, attachments, emojis, reaction emojis, and/or other attachments associated with the messages.

In at least one example, the first user, while composing a message, can include a mention of the third user, such as by including a symbol (e.g., @, $, \hat{ }, #, *, &, etc.) in association with an identifier (e.g., username, real name, user ID, etc.) associated with a third user, in the text of the message. In at least one example, the mention can include an @mention of the third user. For example, the first user can include @thirduser in the text of the message. Though described throughout as including a “@” symbol, this is not intended to be so limiting, and additional or alternative symbols are contemplated herein.

In various examples, in response to identifying the mention of the third user during message composition, the communication platform can determine whether an organization associated with the second user (e.g., intended message recipient) is the same or different from an organization of the third user. That is, the communication platform can determine whether an organization (or group) identifier associated with the third user matches an organization identifier associated with the second user. Based on a determination that the organization of the second user is the same as an organization of the third user (e.g., same organization identifiers), the communication platform can withhold a contact card (e.g., contact information) associated with the third user from presentation in association with the message. Additionally or alternatively, the communication platform can cause an indication of the mention to be presented to the third user, such as in association with a “mentions and reactions” indicator on a user interface associated with the third user. In such examples, the third user can access the message in which they were mentioned (but, in at least one example, not other messages associated with the virtual space).

Based on a determination that the organization of the second user is different from the organization of the third user, the communication platform can cause a contact card associated with the third user to be presented in association with the message. Additionally or alternatively, the communication platform can be configured to cause the contact card of the third user to be presented in association with the message based on a determination that a contact list associated with the second user does not include information associated with the third user. That is, the communication platform can be configured to present a contact card based on a determination that the second user and the third user had not previously connected via the communication platform.

Additionally, in some examples, in response to identifying the mention of the third user during message composition, the communication platform can be configured to determine whether the third user allows contact sharing via messages. In some examples, the communication platform can identify a third user account associated with the third user. The communication platform can determine whether a user preference (or organization preference of an organization of the third user) associated with the third user account enables contact sharing. Based on a determination that the user preference does not permit contact sharing, the communication platform can withhold the contact card from presentation in association with the message. Based on a determination that the user preference permits contact sharing, the communication platform can cause the contact card to be presented in association with the message.

In at least one example, the contact card can include contact information associated with the third user. The contact information can include a real name, username, user ID, an avatar, a telephone number, an email address, a time zone, organization identifier, job title, job position, city, state, country, and/or the like. In various examples, all or a portion of the contact information can be viewable to the second user via the contact card. For example, a first portion of the contact information can be presented on the contact card, such as a name, organization, and avatar of the third user and a second portion of the contact information can be presented in association with a view more info option. In at least one example, the contact card can include a first selectable control to enable communications between the second user and the third user. That is, the first selectable control can, when selected by the second user, cause a messaging interface to be presented to enable the second user to generate and transmit a private message to the third user. The private message can be transmitted via a DM instance, a communication channel, and/or other virtual space of the communication platform.

In some examples, the contact card can include a second selectable control to enable the second user to store data associated with the third user in a contact list (e.g., address book, directory, etc.) associated with the third user. That is, the second selectable control can, when selected by the second user, cause the communication platform to store the contact information of the third user in a contact list of the second user. In such examples, the contact information of the third user may be available to the second user at a later time, such as to send a message, auto complete the third user's name and contact information, re-share the contact information of the third user (e.g., in another contact card) with a fourth user), and/or the like.

In various examples, the communication platform can receive, from an interface associated with the first user, a request to transmit the message with the associated contact card to the second user. Though described as including a single contact card associated with the third user, this is not intended to be so limiting and the message can have a plurality of contact cards associated with different users with whom the second user does not have an established connection (e.g., does not share a same organization, not included in the contact list of the second user, etc.). In response to the request to transmit the message, the communication platform can cause the message with the associated contact card to be presented on an interface associated with the second user. That is, the communication platform can cause the contact card to be presented to the second user, such as to enable the second user to interact with the contact card.

In various examples, in response to receiving an indication of selection of the second selectable option, the communication platform can store the contact information of the third user in a contact list associated with the user. The contact list can be stored in association with a user account of the user and/or an organization account associated with an organization of the user. As such, the contact information associated with the third user can be available to the second user and/or other users of the organization at a later time, such as to initiate communication or the like.

In at least one example, in response to receiving an indication of selection of the first selectable control, the communication platform can cause a first instance of a messaging interface to be presented in association with the second user account. The messaging interface can include an interface associated with a virtual space between the second user and the third user. In various examples, the first instance of the messaging interface can include a composer to enable the second user to compose a private message to the third user to be sent via the virtual space. Additionally, in some examples, the first user can include an introductory message in association with sharing the contact card. In such examples, the introductory message can be presented via the first instance of the messaging interface in addition to the private message composed by the second user, such as to assist in brokering the connection between the second user and the third user. Though in some examples, the messaging interface associated with the virtual space can include the introductory message composed by the first user, the communication platform does not grant the first user access to the virtual space between the second user and the third user. That is, the first user may not have permissions to transmit additional messages via the virtual space after a generation thereof.

In various examples, the communication platform can receive, from the second user, a request to transmit the private message to the third user. In response to the request, the communication platform can cause an indicator associated with the virtual space to be presented on an interface associated with the third user. In some examples, the indicator can include an indication (notification) of a new conversation or message received from a new (e.g., not previously connected) user. In some examples, the indicator can include a notification of a pending private message with another user outside of an organization of the third user (e.g., the second user).

In various examples, in response to receiving, from the third user, an indication of selection of the indicator, the communication platform can cause a second instance of the messaging interface associated with the virtual space to be presented to the third user. The second instance of the messaging interface presented to the third user can include the private message from the second user and/or the introductory message composed by the first user.

In some examples, the second instance of the messaging interface presented to the third user can include selectable controls to accept, ignore, and/or block communications with the second user. In response to receiving an indication of selection of an ignore selectable control, the communication platform can remove the indicator associated with the virtual space from the interface of the third user. In some examples, the communication platform can cause an indication of the virtual space to be presented in an alternative interface (e.g., connect interface), such as that associated with invitations to communicate with other users outside of an organization of the third user. In various examples, the communication platform can cause the indication of the virtual space to be available for viewing and/or response via the alternative interface for a first period of time (e.g., 6 hours, 3 days, 1 week, etc.). In such examples, after an expiration of the first period of time, the communication platform can remove the indication of the virtual space from the alternative interface.

In response to receiving an indication of selection of a block selectable control, the communication platform can prevent future communications from the second user to be presented to the third user. That is, the third user can select the block selectable option to prevent receiving any additional communications from the second user. In some examples, the communication platform can prevent future communications from the second user by disabling the first selectable control and/or the second selectable control associated with the contact card. In some examples, in response to receiving the indication of selection of the block selectable control, the communication platform can remove the contact information associated with the third user from the contact list of the second user. Additionally, in response to receiving the indication of selection of the block selectable control, the communication platform can remove the indicator associated with the virtual space from the interface. In some examples, the communication platform can cause an indication of the virtual space and/or invitation to communicate from the second user to be presented via the alternative interface. In such examples, the indication of the virtual space and/or invitation to communicate from the second user can be presented with a notification that the second user has been blocked from future communications.

In some examples, in response to receiving no input via a selectable control associated with the second instance of the messaging interface (e.g., accept selectable control, ignore selectable control, block selectable control, etc.), the communication platform can cause the indicator to remain on the interface for a second period of time (e.g., 12 hours, 5 days, 2 weeks, etc.). The second period of time can be the same or different from the first period of time. In such examples, after an expiration of the second period of time, the communication platform can remove the indicator from the second instance of the messaging interface.

In response to receiving an indication of selection of an accept selectable control, the communication platform can enable communications via the virtual space. In some examples, the communication platform can generate the virtual space between the second user and the third user. In such examples, the virtual space can be available for the second user and the third user to communicate indefinitely. In some examples, the communication platform can update interfaces associated with the second user and the third user to reflect the virtual space, such as by causing a presentation of an indicator associated therewith on respective interfaces. In such examples, the indicators can be selectable by a respective user to access the virtual space to view and/or contribute to the data transmitted therethrough. Additionally, in response to receiving the indication of selection of the accept selectable control, the communication platform can cause the contact information associated with the third user to be stored in association with the contact list of the second user, and vice versa.

The techniques described herein can improve performance of a user computing device by reducing the number of applications and/or programs running thereon in order to establish a connection via a communication platform. As discussed above, in conventional systems, a first user can provide a second user with contact information (e.g., email address, telephone number, social media handle, etc.) associated with a third user. The second user may then utilize the contact information to reach out and establish a connection with the third user via an alternate means of communication, such as via an email, text, social networking message, or the like. These alternate means of communications (e.g., third-party applications, text messaging, etc.) may require additional processing power and memory of the user computing device, such as to enable the previously unconnected users to connect. Unlike these conventional systems, the techniques described herein include providing a means by which the first user can share a contact card via a communication application associated with the communication platform that can be selectable to establish communications between the second user and the third user via the communication platform. As such, a user computing device associated with the second user may run a single communication application associated with the communication platform, and the second user may select a contact card to quickly and easily establish communications with the third user via the communication application. Due to the ease of access to connect with other users of the communication application, the techniques described herein may improve the user computing device by reducing the total amount of processing power and memory required to broker new connections between users of the communication platform.

Additionally, the techniques described herein can improve collaborative efforts enabled via the communication platform. As discussed above, in traditional systems, a user can receive an invitation to communicate via the communication platform or a third-party application, such as an email application or the like. However, the user may not know the other user associated with the invitation and/or may not know any information about a mutual connection. Because the user doesn't know the other user and/or doesn't have any information about the mutual connection, the user may ignore, block, or otherwise refuse to communicate with the other user. As such, the conventional systems may stifle communications and collaboration via the communication platform. Unlike these conventional systems, the techniques described herein enable users to efficiently and effectively broker connections between other previously unconnected users, thereby improving the overall effectiveness of the communication platform to facilitate collaboration between users.

Furthermore, the techniques described herein provide a better user experience for users associated with a communication platform. As discussed above, in existing systems, the first user can generate a multi-party direct message instance to broker a connection between two previously unconnected users. However, this process can result in the first user receiving notifications of new messages in the multi-party direct message instance that are irrelevant to the first user. Unlike the existing system, the techniques described herein may improve the user experience of the first user by providing a means by which the first user can easily broker a connection and enable the two previously unconnected users to communicate without receiving notifications associated with the conversation between the other users. As such, the techniques described herein may provide an enhanced user experience.

These and other aspects are described further below with reference to the accompanying drawings. The drawings are merely example implementations and should not be construed to limit the scope of the claims. For example, while some examples are illustrated in the context of a user interface for a mobile device, the same or similar techniques may be implemented using any computing device and the user interface may be adapted to the size, shape, and configuration of the particular computing device.

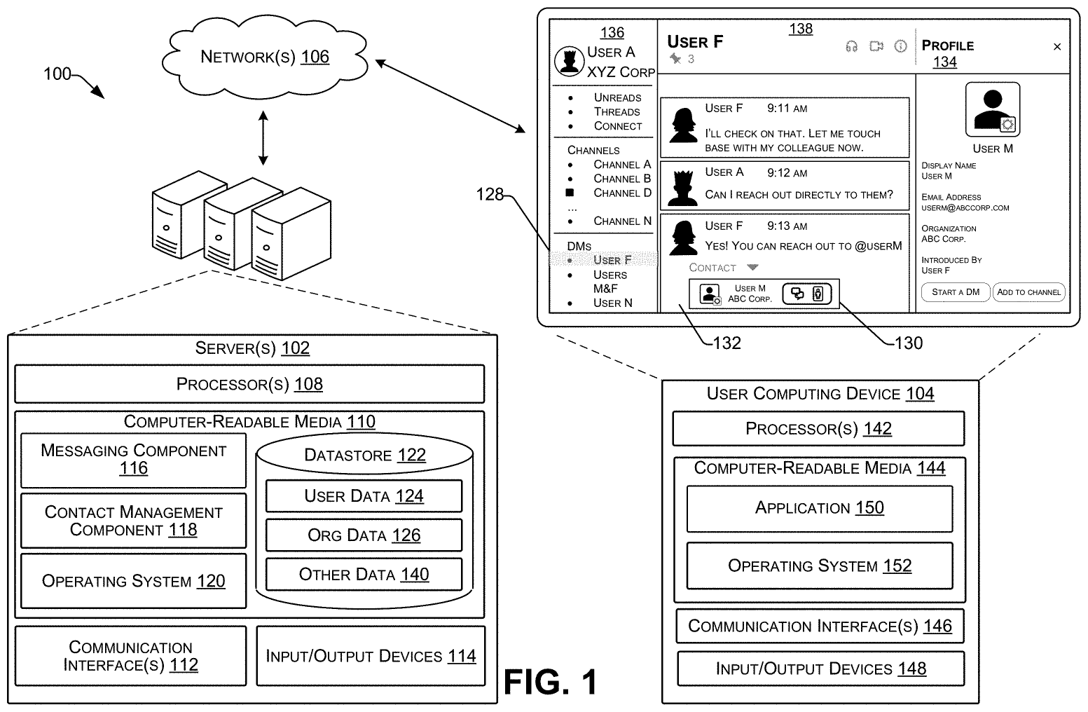

FIG. 1 illustrates an example system 100 for performing techniques described herein. In at least one example, the example system 100 can be associated with a communication platform that can leverage a network-based computing system to enable users of the communication platform to exchange data. In at least one example, the communication platform can be “group-based” such that the platform, and associated systems, communication channels, messages, and/or virtual spaces, have security (that can be defined by permissions) to limit access to a defined group of users. In some examples the communication platform is a channel-based messaging platform. In some examples, such groups of users can be defined by group identifiers, which can be associated with common access credentials, domains, or the like. In some examples, the communication platform can be a hub, offering a secure and private virtual space to enable users to chat, meet, call, collaborate, transfer files or other data, or otherwise communicate between or among each other. In some examples, each group can be associated with a workspace, enabling users associated with the group to chat, meet, call, collaborate, transfer files or other data, or otherwise communicate between or among each other in a secure and private virtual space. In some examples, members of a group, and thus workspace, can be associated with a same organization. In some examples, members of a group, and thus workspace, can be associated with different organizations (e.g., entities with different organization identifiers).

In at least one example, the example system 100 can include one or more server computing devices (or “server(s)”) 102. In at least one example, the server(s) 102 can include one or more servers or other types of computing devices that may be embodied in any number of ways. For example, in the example of a server, the functional components and data can be implemented on a single server, a cluster of servers, a server farm or data center, a cloud-hosted computing service, a cloud-hosted storage service, and so forth, although other computer architectures may additionally or alternatively be used.

In at least one example, the server(s) 102 can communicate with a user computing device 104 via one or more network(s) 106. That is, the server(s) 102 and the user computing device 104 can transmit, receive, and/or store data (e.g., content, information, or the like) using the network(s) 106, as described herein. The user computing device 104 can be any suitable type of computing device, e.g., portable, semi-portable, semi-stationary, or stationary. Some examples of the user computing device 104 can include a tablet computing device, a smart phone, a mobile communication device, a laptop, a netbook, a desktop computing device, a terminal computing device, a wearable computing device, an augmented reality device, an Internet of Things (IOT) device, or any other computing device capable of sending communications and performing the functions according to the techniques described herein. While a single user computing device 104 is shown, in practice, the example system 100 can include multiple (e.g., tens of, hundreds of, thousands of, millions of) user computing devices. In at least one example, user computing devices, such as the user computing device 104, can be operable by users to, among other things, access communication services via the communication platform. A user can be an individual, a group of individuals, an employer, an enterprise, an organization, or the like.

The network(s) 106 can include, but are not limited to, any type of network known in the art, such as a local area network or a wide area network, the Internet, a wireless network, a cellular network, a local wireless network, Wi-Fi and/or close-range wireless communications, Bluetooth®, Bluetooth Low Energy (BLE), Near Field Communication (NFC), a wired network, or any other such network, or any combination thereof. Components used for such communications can depend at least in part upon the type of network, the environment selected, or both. Protocols for communicating over such network(s) 106 are well known and are not discussed herein in detail.

In at least one example, the server(s) 102 can include one or more processors 108, computer-readable media 110, one or more communication interfaces 112, and input/output devices 114.

In at least one example, each processor of the processor(s) 108 can be a single processing unit or multiple processing units, and may include single or multiple computing units or multiple processing cores. The processor(s) 108 can be implemented as one or more microprocessors, microcomputers, microcontrollers, digital signal processors, central processing units (CPUs), graphics processing units (GPUs), state machines, logic circuitries, and/or any devices that manipulate signals based on operational instructions. For example, the processor(s) 108 can be one or more hardware processors and/or logic circuits of any suitable type specifically programmed or configured to execute the algorithms and processes described herein. The processor(s) 108 can be configured to fetch and execute computer-readable instructions stored in the computer-readable media, which may program the processor(s) to perform the functions described herein.

The computer-readable media 110 can include volatile and nonvolatile memory and/or removable and non-removable media implemented in any type of technology for storage of data, such as computer-readable instructions, data structures, program modules, or other data. Such computer-readable media 110 can include, but is not limited to, RAM, ROM, EEPROM, flash memory or other memory technology, optical storage, solid state storage, magnetic tape, magnetic disk storage, RAID storage systems, storage arrays, network attached storage, storage area networks, cloud storage, or any other medium that may be used to store the desired data and that may be accessed by a computing device. Depending on the configuration of the server(s) 102, the computer-readable media 110 can be a type of computer-readable storage media and/or may be a tangible non-transitory media to the extent that when mentioned, non-transitory computer-readable media exclude media such as energy, carrier signals, electromagnetic waves, and signals per se.

The computer-readable media 110 can be used to store any number of functional components that are executable by the processor(s) 108. In many implementations, these functional components comprise instructions or programs that are executable by the processor(s) 108 and that, when executed, specifically configure the processor(s) 108 to perform the actions attributed above to the server(s) 102. Functional components stored in the computer-readable media can optionally include messaging component 116, a contact management component 118, an operating system 120, and a datastore 122.

In at least one example, the messaging component 116 can process messages between users, such as via one or more virtual spaces (e.g., workspaces, communication channels, direct messaging instances, boards, audio and/or video communications, etc.). That is, in at least one example, the messaging component 116 can receive an outgoing message from a user computing device 104 and can send the message as an incoming message to a second user computing device 104. The messages can include direct messages sent from an originating user to one or more specified users and/or virtual space messages sent via a communication channel from the originating user to the one or more users associated with the virtual space. The virtual space can be a data route used for exchanging data between and among systems and devices associated with the communication platform. In at least one example, the messaging component 116 can establish a virtual space between and among various user computing devices, allowing the user computing devices to communicate and share data between and among each other. In at least one example, the messaging component 116 can manage such communications and/or sharing of data, such as contact cards associated with other users. In some examples, data associated with a virtual space can be presented via a user interface.

Further the messaging component 116 can store messages sent between user computing devices in the datastore 122, such as in user data 124 and/or organization data 126 (illustrated as org data 126). In at least one example, the datastore 122 can be configured to store data that is accessible, downloadable, manageable, and updatable. In some examples, the datastore 122 can be integrated with the server(s) 102, as shown in FIG. 1. In other examples, the datastore 122 can be located remotely from the server(s) 102 and can be accessible to the server(s) 102 and/or user computing device(s), such as the user computing device 104. Additional or alternative data can be stored in the datastore 122 and/or in one or more other data stores.

In at least one example, the contact management component 118 can be configured to identify, in a communication 132 (e.g., a message) composed by a first user and directed to at least a second user, a mention of a third user. The mention can include a symbol (e.g., @, $, \hat{ }, #, *, &, etc.) in association with an identifier (e.g., username, real name, user ID, etc.) associated with the third user. In at least one example, the mention can include an @mention of the third user. In various examples, based on the mention, the contact management component 118 can identify an organization of the second user and an organization of the third user. That is, the contact management component 118 can identify an organization (or group) identifier associated with a second user account of the second user and an organization identifier associated with a third user account of the third user.

Based on a determination that the organizations of the second user and the third user (e.g., organization identifiers) are substantially the same (e.g., at least a portion of the organization identifiers match, the at least the portion indicating that the second user and the third user are associated with a same organization), the contact management component 118 can withhold, from a user interface 128, a contact card 130 from presentation in association with the communication 132. Additionally or alternatively, the contact management component 118 and/or the messaging component 116 can cause an indication of the mention to be presented to the third user, such as in association with a “mentions and reactions” indicator on a user interface associated with the third user. In at least one example, the indication of the mention may provide a means by which the third user may access data associated with the communication in which they were mentioned.

Based on a determination that the organization of the second user is different from the organization of the third user, the contact management component 118 can cause a contact card 130 associated with the third user to be presented in association with the communication 132. In some examples, the contact management component 118 can identify a user account associated with the third user (e.g., third user account). In such examples, the contact management component 118 can determine, based on the third user account, whether a user preference associated therewith enables the presentation of the contact card 130. That is, the third user can establish, in a user preference associated with the third user account, a user preference to enable the contact cards to be shared by other users or not. In some examples, the contact management component 118 can additionally determine whether an organization preference associated with the organization of the third user permits the presentation of contact cards associated with members of the organization. That is, an organization may establish a preference (e.g., org preference) enabling or preventing contact cards associated with one or more members of the organization to be shared. The org preference to allow (or not allow) contact cards to be shared can be associated with select members. For example, an org preference can enable contact cards to be shared with a first group of members of the organization and not with a second group of members, such as members associated with a board or corporate suite of the organization.

In some examples, the user/org preference can include a preference to enable particular other users to share the contact card 130 associated with the third user. In such examples, the user/org preference can identify the particular other people, such as by name, identifier, group identifier (e.g., people from a same organization, etc.), contacts listed as favorites (e.g., friends, family, or otherwise indicated as having a relationship with the user), and/or the like. For example, in response to receiving the mention of the third user in association with the message composition, the contact management component 118 can determine whether a user/org preference of the third user enables contact information sharing and/or enables the first user to share contact information associated with the third user.

In some examples, the contact management component 118 can identify a contact card 130 associated with the third user, such as that associated with the third user account. The contact card 130 can include contact information associated with the third user. The contact information can include a real name, username, user ID, an avatar, a telephone number, an email address, a time zone, organization identifier, job title, job position, city, state, country, and/or the like. In various examples, all or a portion of the contact information can be viewable to the second user via the contact card 130. In some examples, the contact card 130 can include basic information about the associated user and/or a selectable option to view additional information about the associated user. For example, the contact card 130 can include a name, organization, avatar, and email address associated with the third user. For another example, a first portion of the contact information can be presented on the contact card 130, such as a name, organization, avatar, and email address of the third user and a second portion of the contact information can be presented in association with a view more info option.

In some examples, the contact management component 118 can, based on the mention and the determination of different organizations, generate the contact card 130 associated with the third user. In some examples, the contact card 130 can be generated based on one or more user preferences associated with the third user account. In such examples, the contact management component 118 can include particular contact information in the contact card 130 based on the one or more user preferences. For example, an account of the third user may include a preference to include an avatar and a username associated with the third user in the contact card 130. For another example, an account of the third user may include a preference to include a username and a telephone number associated with the third user in the contact card 130.

As discussed above, the contact management component 118 can cause the contact card 130 of the third user to be presented on the user interface 128 in association with the communication 132 based on a determination that the third user is associated with an organization (or group) that is different from an organization associated with the second user (e.g., intended recipient of the communication). Additionally or alternatively, the contact management component 118 can be configured to cause the contact card 130 of the third user to be presented in association with the communication 132 based in part on a determination that the third user is not included in a contact list (e.g., address book, directory, etc.) associated with the second user. As discussed above, the contact management component 118 can identify a second user account associated with the second user or intended recipient of the communication 132. The contact management component 118 can access the contact list associated with the second user account to determine whether the third user and/or contact information associated therewith is included in the contact list of the second user. That is, the contact management component 118 can be configured to identify whether the second user and the third user have a previously established connection. Based on a determination that the second user and the third user have previously established a connection (e.g., contact information associated with the third user is included in the contact list associated with the second user), the contact management component 118 can determine to withhold the contact card 130 from presentation in association with the communication 132. Based on a determination that the second user and the third user have not previously established a connection, the contact management component 118 can cause the contact card 130 associated with the third user to be presented in association with the communication 132.

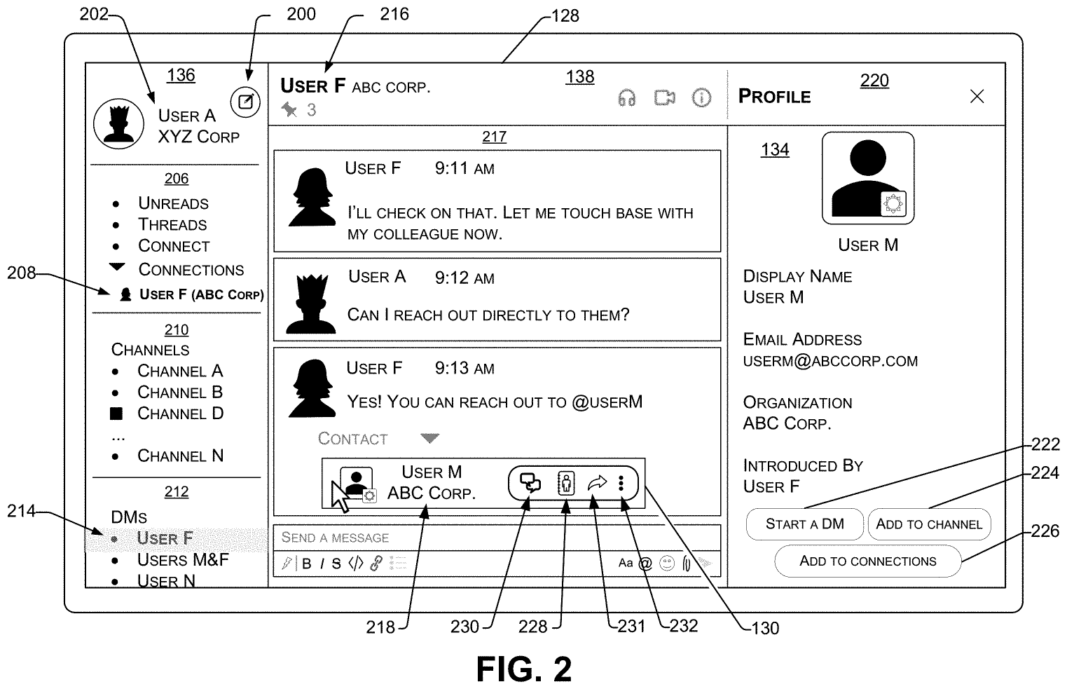

As will be discussed in greater detail below with regard to FIG. 2, the contact card 130 can include a first selectable control associated with sending a private message to the user associated with the contact card 130 (e.g., the third user). In such examples, responsive to receiving an indication of selection of the first selectable control, the contact management component 118 can cause a messaging interface to be presented on the associated computing device. The private message can be transmitted via a DM instance, a communication channel, workspace, board, and/or other virtual space of the communication platform. In some examples, in response to receiving the indication of selection of the first selectable control, the contact management component 118 can be configured to automatically add contact information associated with the third user to a contact list associated with the second user. That is, in response to receiving a request to initiate a private message between the second user and the third user, the contact management component 118 can associate contact information of the third user with the contact list of the second user.

In some examples, the contact card 130 can additionally include a second selectable control associated with adding the contact information associated with the contact card 130 to a contact list of a recipient of the communication 132 (e.g., the second user). In such examples, responsive to receiving an indication of selection of the second selectable control the contact management component 118 can cause the contact information of the third user to be included in the contact list associated with the second user. That is, the second selectable control can enable the second user to store contact information associated with the third user, such as for generating and sending a message to the third user independent of the communication including the contact card 130.

In some examples, the contact management component 118 can associate an indication of whether a connection request has been accepted by the third user, such as in association with the contact information of the third user stored in the contact list of the second user. That is, the contact management component 118 may store an indicator in association with the contact information of the third user in the contact list associated with the second user, indicating that a connection has been established (e.g., third user accepts a messaging connection from the second user) or has not been established (e.g., third user has not yet accepted the messaging connection, third user denies or ignores the messaging connection, etc.). In some examples, in response to receiving a request, from the third user, to block the second user (e.g., prevent additional messages from the second user), the contact management component 118 can mute, grey out, or otherwise render contact information associated with the third user not selectable to the second user via the contact list.

In various examples, the contact management component 118 can render the contact card 130 itself selectable, such as to enable access to additional contact information associated with the third user. That is, in response to receiving an indication of selection of the contact card 130, the contact management component 118 can cause a user profile 134 including additional contact information to be presented via the user interface 128. The user profile 134 can include additional information associated with the third user, that is not included in the contact card 130. In some examples, the additional information may be predetermined by the contact management component 118, such that it is the same for each contact card shared via the communication platform. In some examples, the additional information may be identified based on a user and/or org preference associated with the third user. The user interface 128 can present data associated with the user profile 134 (e.g., the additional data) independently of and/or concurrently with the contact card 130.

Additionally, as illustrated in FIG. 1, the user interface 128 can present data associated with one or more communication channels, direct messaging instances, and, in some examples, one or more workspaces. In some examples, the user interface 128 can include a first region 136, or pane, that includes indicator(s) (e.g., user interface element(s) or object(s)) associated with virtual space(s) with which the user (e.g., account of the user) is associated. In some examples, in response to receiving an indication of selection of an indicator associated with a particular virtual space, the user interface 128 can cause a presentation of data associated therewith to be presented in a second region 138, or pane. In some examples, the second region 138 can be associated with a data feed (or, “message feed”) indicating messages posted to and/or actions taken with respect to one or more communication channels, direct messaging instances, and/or other virtual spaces for facilitating communications (e.g., a virtual space associated with event(s) and/or action(s), etc.) as described herein. Additional details associated with the user interface 128, and the second region 138, are described below with reference to FIG. 2.

In at least one example, the datastore 122 can be configured to store data that is accessible, manageable, and updatable. In some examples, the datastore 122 can be integrated with the server(s) 102, as shown in FIG. 1. In other examples, the datastore 122 can be located remotely from the server(s) 102 and can be accessible to the server(s) 102 and/or user device(s), such as the user computing device 104. The datastore 122 can comprise multiple databases, which can include user data 124, organization data 126, as discussed above, and/or other data 140. Additional or alternative data can be stored in the data store and/or one or more other data stores.

In at least one example, the user data 124 can store data associated with users of the communication platform. In at least one example, the user data 124 can store data in user profiles (which can also be referred to as “user accounts”), which can store data associated with a user, including, but not limited to, one or more user identifiers associated with multiple, different organizations or entities with which the user is associated, one or more communication channel identifiers associated with communication channels to which the user has been granted access, one or more group identifiers for groups (or, organizations, teams, entities, or the like) with which the user is associated, an indication whether the user is an owner or manager of any communication channels, an indication whether the user has any communication channel restrictions, a plurality of messages, a plurality of emojis, a plurality of conversations, a plurality of conversation topics, an avatar, an email address, a real name (e.g., John Doe), a username (e.g., jdoe, j doe, etc.), a password, a time zone, a status, a token, and the like.

In at least one example, the organization data 126 can store data in organizational profiles (which can also be referred to as “organization accounts”), which can store data associated with an organization, including, but not limited to, one or more organization identifiers, one or more communication channel identifiers associated with the organization, one or more group identifiers for groups (or, organizations, teams, entities, or the like) associated with the organization, an administrator identifier, organizational preferences, content transmitted via the communication platform in association with the organization (e.g., messages, emojis, conversations, documents, etc.), user identifiers associated with the organization, and the like.

In various examples, the other data 140 can include channel data associated with individual communication channels. The communication channels can allow the user computing devices to communicate and share data between and among each other. In at least one example, each communication channel can be assigned a communication channel identifier, which indicates the physical address in the channel data where data related to that communication channel is stored. A communication channel can be “public,” which can allow any user within an organization (e.g., associated with an organization identifier) to join and participate in the data sharing through the communication channel, or a communication channel can be “private,” which may restrict data communications in the communication channel to certain users or users having particular roles (e.g., managers, administrators, etc.). In some examples, a communication channel can be “shared,” which can allow users associated with different organizations (e.g., entities associated with different organization identifiers) to join and participate in the data sharing through the communication channel. Shared channels can be public such that they are accessible to any user of either organization, or they can be private such that they are restricted to access by certain users or users having particular roles from both organizations.

In various examples, the other data 140 can include direct messaging instance data associated with direct messaging instances. The direct messaging instances can allow the user computing devices to communicate and share data between and among each other, such as in private conversations. A direct messaging instance can include two or more users. In at least one example, each direct messaging instance can be assigned a direct messaging instance identifier, which indicates the physical address in the channel data where data related to that communication channel is stored. In some examples, each direct messaging instance can include user identifiers associated with users associated therewith.

In some examples, the datastore 122 can be partitioned into discrete items of data that may be accessed and managed individually (e.g., data shards). Data shards may simplify many technical tasks, such as data retention, unfurling (e.g., detecting that message contents include a link, crawling the link's metadata, and determining a uniform summary of the metadata), and integration settings. In some examples, data shards can be associated with organizations, groups (e.g., workspaces), communication channels, users, or the like.

In some examples, individual organizations can be associated with a database shard within the datastore 122 that stores data related to a particular organization identification. For example, a database shard can store electronic communication data associated with members of a particular organization, which enables members of that particular organization to communicate and exchange data with other members of the same organization in real time or near-real time. In this example, the organization itself can be the owner of the database shard and has control over where and how the related data is stored. In some examples, a database shard can store data related to two or more organizations (e.g., as in a shared channel).

In some examples, individual groups can be associated with a database shard within the datastore 122 that stores data related to a particular group identification (e.g., workspace). For example, a database shard can store electronic communication data associated with members of a particular group, which enables members of that particular group to communicate and exchange data with other members of the same group in real time or near-real time. In this example, the group itself can be the owner of the database shard and has control over where and how the related data is stored.

In some examples, a virtual space (e.g., communication channel, direct messaging instance, board, workspace, etc.) can be associated with a database shard within the datastore 122 that stores data related to a particular virtual space identification (e.g., virtual space identifier). For example, a database shard may store electronic communication data associated with the virtual space, which enables members of that particular virtual space to communicate and exchange data with other members of the same virtual space in real time or near-real time. In this example, a group or organization may be the owner of the database shard and may control where and how the related data is stored.

In some examples, individual users can be associated with a database shard within the datastore 122 that stores data related to a particular user account. For example, a database shard can store electronic communication data associated with an individual user, which enables the user to communicate and exchange data with other users of the communication platform in real time or near-real time. In some examples, the user itself can be the owner of the database shard and has control over where and how the related data is stored.

The communication interface(s) 112 can include one or more interfaces and hardware components for enabling communication with various other devices (e.g., the user computing device 104), such as over the network(s) 106 or directly. In some examples, the communication interface(s) 112 can facilitate communication via Websockets, Application Programming Interfaces (APIs) (e.g., using API calls), HyperText Transfer Protocols (HTTPs), etc.

The server(s) 102 can further be equipped with various input/output devices 114 (e.g., I/O devices). Such I/O devices 114 can include a display, various user interface controls (e.g., buttons, joystick, keyboard, mouse, touch screen, etc.), audio speakers, connection ports and so forth.

In at least one example, the user computing device 104 can include one or more processors 142, computer-readable media 144, one or more communication interfaces 146, and input/output devices 148.

In at least one example, each processor of the processor(s) 142 can be a single processing unit or multiple processing units, and may include single or multiple computing units or multiple processing cores. The processor(s) 142 can comprise any of the types of processors described above with reference to the processor(s) 108 and may be the same as or different from the processor(s) 108.

The computer-readable media 144 can comprise any of the types of computer-readable media 144 described above with reference to the computer-readable media 110 and can be the same as or different from the computer-readable media 110. Functional components stored in the computer-readable media can optionally include an application(s) 150 and an operating system 152.

In at least one example, the application(s) 150 can include a mobile application, a web application, or a desktop application, which can be provided by the communication platform or which may be an otherwise dedicated application. In some examples, individual user computing devices associated with the system 100 can have an instance or versioned instance of the application(s) 150, which can be downloaded from an application store, accessible via the Internet, or otherwise executable by the processor(s) 142 to perform operations as described herein. That is, the application(s) 150 can be an access point, enabling the user computing device 104 to interact with the server(s) 102 to access and/or use communication services available via the communication platform. In at least one example, the application(s) 150 can facilitate the exchange of data between and among various other user computing devices, for example via the server(s) 102. In at least one example, the application(s) 150 can present user interfaces, as described herein. In at least one example, a user may interact with the user interfaces via touch input, keyboard input, mouse input, spoken input, or any other type of input, enabled by the I/O devices 148. Additional details associated with the user interfaces will be discussed with regard to FIG. 2.

In at least one example, the operating system 152 can manage the processor(s) 142, computer-readable media 144, hardware, software, etc. of the user computing device 104.

The communication interface(s) 146 can include one or more interfaces and hardware components for enabling communication with various other devices (e.g., the user computing device 104), such as over the network(s) 106 or directly. In some examples, the communication interface(s) 146 can facilitate communication via Websockets, APIs (e.g., using API calls), HTTPs, etc.

The user computing device 104 can further be equipped with various input/output devices 148 (e.g., I/O devices). Such I/O devices 148 can include a display, various user interface controls (e.g., buttons, joystick, keyboard, mouse, touch screen, etc.), audio speakers, connection ports and so forth.

While techniques described herein are described as being performed by the messaging component 116, the contact management component 118, and the application(s) 150, techniques described herein may be performed by any other component, or combination of components, which may be associated with the server(s) 102, the user computing device 104, or a combination thereof.

FIG. 2 is a schematic view of an example user interface 128 associated with a communication platform through which a user can access contact information associated with another user via a contact card 130, as described above with reference to FIG. 1.

As described above, in at least one example, the user interface 128 can include a first region 136, or pane, that includes indicator(s) (e.g., user interface element(s) or object(s)) representing virtual space(s) with which the user (e.g., account of the user) is associated. In some examples, the virtual space(s) can include virtual spaces associated with a single workspace. In such examples, responsive to receiving an indication of selection of a particular workspace, the communication platform can cause the virtual space(s) to be presented in the first region 136. In some examples, the virtual space(s) presented in the first region 136 can include virtual spaces that are associated with two or more workspaces.

In the illustrative example, the first region 136 includes a compose selectable control 200 that enables a user 202 (e.g., User A) to compose a message to another user. For purposes of this discussion, a “message” can refer to any electronically generated digital object provided by a user using the user computing device 104 and that is configured for display within a communication channel and/or other virtual space for facilitating communications (e.g., a virtual space associated with direct message communication(s), etc.) as described herein. A message can include any text, image, video, audio, or combination thereof provided by a user (using a user computing device). For instance, the user can provide a message that includes text, as well as an image and a video, within the message as message contents. In such an example, the text, image, and video would comprise the message. Each message sent or posted to a communication channel of the communication platform can include metadata comprising a sending user identifier, a message identifier, message contents, a group identifier, a communication channel identifier, or the like. In at least one example, each of the foregoing identifiers can comprise American Standard Code for Information Interchange (ASCII) text, a pointer, a memory address, or the like.

In at least one example, the first region 136 can include one or more sub-sections, or sub-panes, which can represent different virtual spaces. For example, a first sub-section 206 can include indicators representing virtual spaces that can aggregate data associated with a plurality of communication channels and/or workspaces. In at least one example, each virtual space can be associated with an indicator in the first sub-section 206. In some examples, an indicator can be associated with an actuation mechanism such that when actuated, can cause one of the one or more application(s) 150 (e.g., a communication platform application) to present data associated with the corresponding virtual space via the second region 138. In some examples, a virtual space can be associated with all unread data associated with each of the workspaces with which the user is associated. That is, in some examples, if the user requests to access the virtual space associated with “unreads,” all data that has not been read (e.g., viewed) by the user can be presented in the second region 138, for example in a feed. In such examples, different types of events and/or actions, which can be associated with different communication channels and/or virtual spaces, can be presented via a same feed. In some examples, such data can be organized and/or is sortable by workspace, time, type of action, communication channel, user, or the like. In some examples, such data can be associated with an indication of which user (e.g., member of the communication channel) posted the message and/or performed an action.

In some examples, each virtual space can be associated with a same type of event and/or action. For example, “threads” can be associated with messages, files, etc. posted in threads to messages posted in a communication channel and “mentions and reactions” (e.g., “M & R”) can be associated with messages or threads where the user (e.g., User A) has been mentioned (e.g., via a tag) or another user has reacted (e.g., via an emoji, reaction, or the like) to a message or thread posted by the user. That is, in some examples, same types of events and/or actions, which can be associated with different communication channels and/or virtual spaces, can be presented via a same feed. As with the “unreads” virtual space, data associated with such virtual spaces can be organized and/or is sortable by workspace, time, type of action, communication channel, user, or the like.

In at least one example, a virtual space can be associated with facilitating communications between the user 202 and other users of the communication platform (illustrated as a select icon). For example, “connect” can be associated with enabling the user 202 to connect with one or more users associated with an organization that is different from an organization of the user 202 (e.g., organization other than XYZ Corp). In some examples, the first sub-section 206 can additionally include a list of connections between the user 202 and users associated with other organizations. For example, “connections” may include a connection indicator 208 associated with a connection between the user 202 (e.g., User A) and another user of a different organization (e.g., User F of ABC Corp.). In some examples, responsive to receiving an indication of selection of the connection indicator 208, the communication platform can cause a virtual space associated with the connection between the two users to be presented in the second region 138. In some examples, in response to identifying that the virtual space associated with the connection between the two users is active (e.g., data associated therewith is presented in the second region 138), the communication platform can modify the connection indicator 208 to indicate that the connection is active. For example, the connection indicator 208 is presented in bold font. Though this is not intended to be so limiting and the indication that the connection is active can include additional or alternative indications, such as a symbol (e.g., *, !, etc.), underline, italics, and/or the like.

In at least one example, the first region 136 of the user interface 128 can include a second sub-section 210, or sub-pane, that includes indicators representing communication channels. In some examples, the communication channels can include public channels, private channels, shared channels (e.g., between groups or organizations), single workspace channels, cross-workspace channels, combinations of the foregoing, or the like. In some examples, the communication channels represented can be associated with a single workspace. In some examples, the communication channels represented can be associated with different workspaces (e.g., cross-workspace). In at least one example, if a communication channel is cross-workspace (e.g., associated with different workspaces), the user can be associated with both workspaces, or can only be associated with one of the workspaces. In some examples, the communication channels represented can be associated with combinations of communication channels associated with a single workspace and communication channels associated with different workspaces.

In some examples, the second sub-section 210 can depict all communication channels, or a subset of all communication channels, that the user has permission to access (e.g., as determined by the permission data stored in association with communication platform user data 124 and/or org data 126). In such examples, the communication channels can be arranged alphabetically, based on most recent interaction, based on frequency of interactions, based on communication channel type (e.g., public, private, shared, cross-workspace, etc.), based on workspace, in user-designated sections, or the like. In some examples, the second sub-section 210 can depict all communication channels, or a subset of all communication channels, that the user is a member of, and the user can interact with the user interface 128 to browse or view other communication channels that the user is not a member of but are not currently displayed in the second sub-section 210. In some examples, different types of communication channels (e.g., public, private, shared, cross-workspace, etc.) can be in different sections of the second sub-section 210, or can have their own sub-regions or sub-panes in the user interface 128. For example, shared channels can be presented in association with the “connect” indicator illustrated in the first sub-section 206, such as in a drop-down menu. In some examples, communication channels associated with different workspaces can be in different sections of the second sub-section 210, or can have their own regions or panes in the user interface 128.

In some examples, the indicators can be associated with graphical elements that visually differentiate types of communication channels. For example, Channel D is associated with a square visual element instead of a circle visual element. As a non-limiting example, and for the purpose of this discussion, the square visual element can indicate that the user is not a current member of Channel D, whereas the circle visual element can indicate that the user is a current member of Channels A, B, and N. In some examples, additional or alternative graphical elements can be used to differentiate between public communication channels, private communication channels, shared communication channels, communication channels associated with different workspaces, and the like. In other examples, communication channels that the user is not a current member of may not be displayed in the second sub-section 210 of the user interface 128. In such examples, the user can navigate to a different interface (not shown) to browse additional channels that are accessible to the user but to which the user is not currently a member.

In addition to the second sub-section 210, the first region 136 of the user interface 128 can include a third sub-section 212, or sub-pane, that includes include indicators representative of communications with individual users or multiple specified users (e.g., instead of all, or a subset of, members of an organization). Such communications can be referred to as “direct messaging instances” or “direct messages.” That is, the third sub-section 212, or sub-pane, can include indicators representative of virtual spaces that are associated with private messages between two or more users (e.g., direct messaging instances). For example, an indicator 214 can represent a direct messaging instance (e.g., private messaging instance) between the user 202 and another user 216 (e.g., User F).

In some examples, responsive to receiving an indication of selection of the indicator 214, the communication platform can cause the direct messaging instance (e.g., virtual space) between the user 202 and the other user 216 to be presented in the second region 138. In some examples, in response to the indication of selection of the indicator 214 and/or a determination that the direct messaging instance is active, the communication platform can provide an indication that the direct messaging instance is active in association with the indicator 214. For example, the indicator 214 is presented in bold font and with a shaded portion covering the indicator 214. Though this is not intended to be so limiting and the indication that the connection is active can include additional or alternative indications, such as a symbol (e.g., *, !, etc.), underline, italics, and/or the like.

As described above, in at least one example, the user interface 128 can include a second region 138, or pane, for presenting data associated with the communication platform, such as data associated with one or more communication channels, direct messaging instances, workspaces, boards, and/or other virtual spaces. As illustrated in FIG. 2, the second region 138 can present data that is associated with a feed indicating messages posted to and/or actions taken with respect to a direct messaging instance 217 between the user 202 and the other user 216.

As illustrated in FIG. 2, a communication or message 132 transmitted in association with the direct messaging instance 217 can include a contact card 130. As described above with regard to FIG. 1, the communication platform (e.g., contact management component 118) can be configured to identify, during composition of the communication 132, a mention of a user 218 who is not associated with the associated virtual space (e.g., direct messaging instance 217). The mention can include a symbol (e.g., @, $, \hat{ }, #, *, &, etc.) in association with an identifier (e.g., username, real name, user ID, etc.) associated with the user 218. In at least one example, the mention can include an @mention of the user 218.

In various examples, based on the mention, and during composition of the message 132, the communication platform can identify whether an organization of the intended recipient of the communication 132 (e.g., XYZ Corp of User A) is different from an organization of the user 218 (e.g., ABC Corp) user. That is, the contact management component 118 can identify whether an organization (or group) identifier associated with the user 202 (e.g., intended recipient of the communication 132) is separate and distinct from an organization associated with the user 218.

Based on a determination that the organization of the user 202 is different from the organization of the user 218, the communication platform can cause the contact card 130 associated with the user 218 to be presented in association with the communication 132. In some examples, the communication platform can cause the contact card 130 associated with the user 218 to be presented based on a determination that a user preference and/or an organization preference associated with the user 218 enables contact card sharing.

As described above, the communication platform can, in some examples, identify the contact card 130 in user data 124, such as that stored in association with the user 218. In such examples, the communication platform may store previously generated contact cards associated with users in the user data 124. In some examples, the communication platform can generate the contact card 130 in response to determining to include the contact card 130 in association with the communication 132 (e.g., receiving the input of the mention and determining that the users 202 and user 218 are associated with different organizations). In various examples, the communication platform can generate the contact card 130 based on predetermined criteria associated with contact cards, as determined by the communication platform. In some examples, the communication platform can generate the contact card 130 based on user preferences and/or organization preferences associated with the user 218 and/or the organization of the user 218 (e.g., ABC Corp).

In various examples, the contact card 130 can include a selectable control that, when selected (as illustrated in FIG. 2) causes a user profile 134 to be presented via the user interface 128. In the illustrative example, the user profile 134 is presented in a third region 220 of the user interface 128. In other examples, the user profile 134 may be presented in a window or other viewing element associated with the user interface 128.

In various examples, the user profile 134 can include additional information associated with the user 218. In some examples, the additional information can include contact information included in the contact card 130, as well as other information, such as an email address, physical address (e.g., city, state, country, etc.), time zone, working location, telephone number, job title, job position, an indication of the user 216 who provided the introduction, and/or other information stored in association with the user 218. In some examples, the user profile 134 can include a message selectable control 222 configured to facilitate communications between the user 202 and the user 218. In some examples, in response to receiving an indication of selection of the message selectable control 222, the communication platform can cause a presentation of a messaging interface between the user 202 and the user 218 on the user interface 128.

In some examples, the user profile 134 can include an add to channel selectable control 224 configured to facilitate sending an invitation to include the user 218 in a particular communication channel. In various examples, in response to receiving an indication of selection of the add to channel selectable control 224, the communication platform can request additional information from the user 202, such as in a window or section of the user interface 128. In various examples, the request for additional information can include a request to specify a channel to which the user 218 will be invited. In response to receiving the additional information, the communication platform can send an invitation to the user 218 to join the channel and/or automatically associate the user 218 with the channel. In various examples, the communication platform can determine whether to send the invitation or automatically associate the user 218 based on a user preference and/or organization preference associated with the user 218 and/or an owner or administrator of the channel. Though illustrated and described as a selectable control to add the user 218 to a channel, this is not intended to be so limiting, and the add to channel selectable control 224 can include an option to add the user 218 to additional or alternative virtual spaces, such as a workspace, an audio or video conversation, a board, or the like.

In some examples, the user profile 134 can include an add to connections selectable control 226. In some examples, in response to receiving an indication of selection of the add to connections selectable control 226, the communication platform can include data associated with the user 218 to be presented in the first sub-section 206, such as in association with the “connections.” In such examples, the user 202 can initiate a connection (e.g., send a message) to the user 218 by selecting an indicator associated with the user 218, such as the connection indicator 208 (associated with User F). In some examples, in response to receiving an indication of selection of the add to connections selectable control 226, the communication platform can include data associated with the user 218 in a contact list (e.g., directory, address book, etc.) of the user 202. That is, the add to connections selectable control 226 can enable the user 202 to store contact information associated with the user 218, such as for generating and sending a message to the user 218 independent of the message 132 including the contact card 130.

Additionally or alternatively, the contact card 130 can include an add contact selectable control 228 that, when selected, can cause the communication platform to store contact information associated with the user 218 in the contact list of the user 202. In some examples, responsive to receiving an indication of selection of the add contact selectable control 228, the communication platform can cause the contact information of the user 218 to be included in the contact list associated with the user 202. In some examples, the communication platform can determine that contact information associated with the user 218 was previously stored in association with a contact list of the user 202. In such examples, the communication platform can withhold the add contact selectable control 228 from presentation via the contact card. That is, in response to determining that a contact list of the user 202 includes at least a portion of the contact information associated with the user 218, the communication platform can withhold, from presentation, the add contact selectable control 228.

In various examples, the contact card 130 can include a messaging selectable control 230 to enable communications between the user 202 and the user 218. That is, the messaging selectable control 230 can, when selected by the user 202, cause a messaging interface (e.g., message composer interface) to be presented to enable the user 202 to generate and transmit a private message to the user 218. The private message can be transmitted via a DM instance, a communication channel, and/or other virtual space of the communication platform.

In some examples, the contact card 130 can include a share contact selectable control 231 to enable a user viewing the contact card 130 to re-share the contact card 130 with another person (e.g., another user), such as in association with another message. That is, the share contact selectable control 231 can, when selected by the user 202, cause a messaging interface to be presented to enable the user 202 to share the contact card 130 with another user of the communication platform.

In some examples, the contact card 130 can additionally include a more info selectable control 232 that, when selected, can provide additional or alternative information associated with the user 218 and/or an organization thereof (e.g., ABC Corp.) that may be available to the user 202. In some examples, the more info selectable control 232 can include an option to view the user profile 134 that, when selected, causes the user profile 134 to be presented in the third region 220, in a window, or other location on the user interface 128. In some examples, the more info selectable control 232 can include an option to re-share the contact card 130, such as in association with a share contact selectable control 231 that is accessible via the more info selectable control 232.

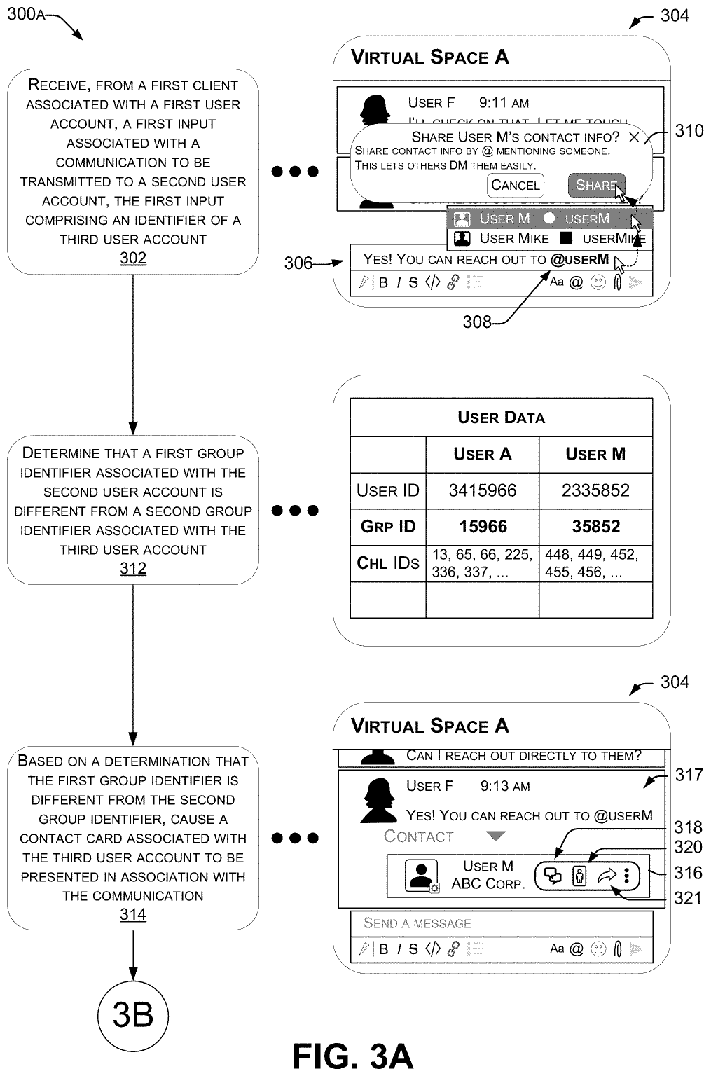

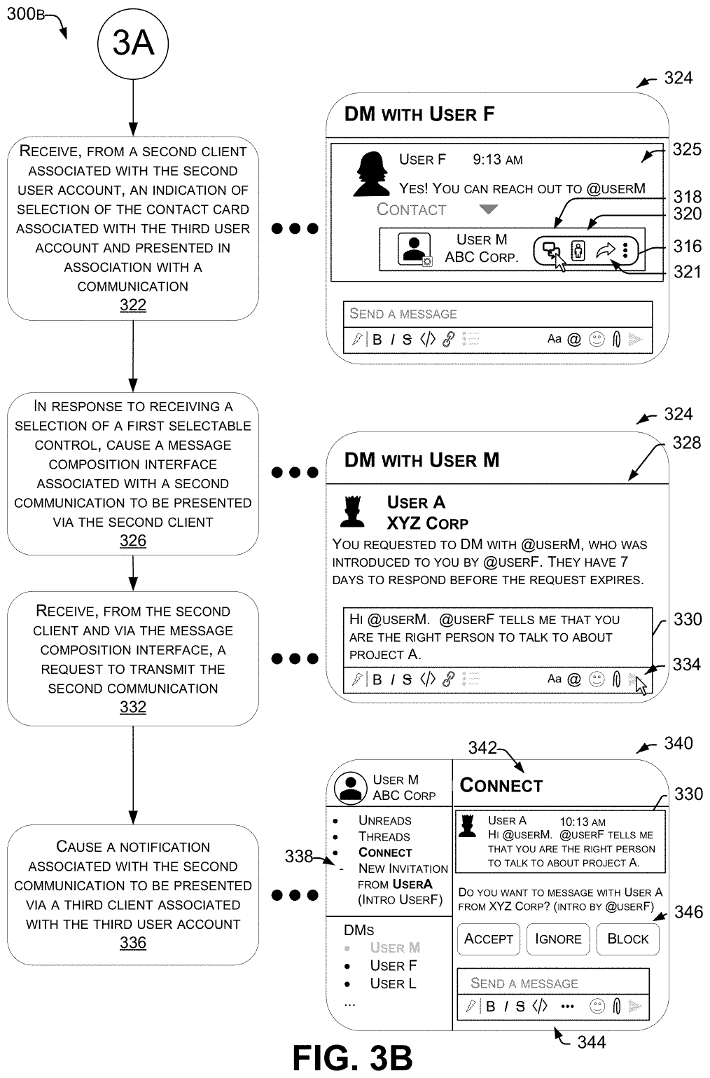

FIG. 3A is an example process 300A for presenting a contact card associated with a user in association with a communication that is transmitted via a communication platform. In some examples, some or all of process 300A may be performed by one or more components in the system 100. By way of example and not limitation, the communication platform referred to in process 300A may be representative of a computing device associated with the (communication platform) server(s) 102, the first user computing device referred to in process 300A may be representative of the user computing device(s) 104. However, the process 300A is not limited to being performed by the system 100.

At operation 302, the communication platform receives, from a first client 304 associated with a first user, a first input 306 associated with a communication to be transmitted to a second user account, the first input 306 comprising an identifier of a third user account. The identifier 308 can include a username, code, symbol, and/or any other unique identifier that is associated with the third user account. In at least one example, the identifier 308 can include a mention of the third user, such as an @thirduser. Though other symbols and/or identifiers are contemplated herein.

In some examples, the communication platform can determine that a portion of the identifier 308 is being input during message composition and can identify one or more users associated with the portion of the identifier 308. For example, in response to determining that the portion of the identifier 308 includes “userM,” the communication platform identifies two user accounts that correspond to the portion of the identifier 308, “User M” and a “User Mike.” In various examples, the communication platform may receive an indication of selection of one of the two user accounts, and may continue with the process 300A, based on the indication of selection (e.g., the selection).

In some examples, the communication platform can be configured to cause a presentation of a share contact confirmation window 310 in association with the identifier 308 input in association with the communication and/or the selection of the user account. In various examples, the share contact confirmation window 310 may include a query associated with sharing contact information associated with the user associated with the identifier 308 (e.g., user associated with the third user account). In some examples, the share contact confirmation window 310 can include selectable controls to enable the first user to either share the contact information or cancel an action associated with sharing the contact information.

At operation 312, the communication platform determines that a first group identifier associated with the second user account is different from a second group identifier associated with the third user account. In various examples, the communication platform can compare the first group identifier to the second group identifier based on receiving a selection (or indication of selection) of the selectable control to share contact information associated with the third user account. In some examples, the communication platform can compare the first group identifier to the second group identifier based on determining that the identifier 308 is included in the first input 306.

In various examples, the communication platform determines that the first group identifier and the second group identifier include a threshold difference in numbers, characters, symbols, and/or the like. In such examples, the threshold difference can indicate that the organization associated with the second user account is different from an organization that is associated with the third user account.

In some examples, the communication platform can additionally or alternatively determine whether the second user account and the third user account had previously established a connection (e.g., had previously connected, communicated, etc. via the communication platform). In some examples, the communication platform may identify a previously established connection based on a determination that contact information associated with the third user is stored in association with a contact list (e.g., directory, address book, etc.) of the second user. In some examples, the communication platform may determine that the contact information associated with the third user is stored in the contact list of the second user based on a determination that a user identifier associated with the third user is associated with the contact list of the second user. In some examples, based on the determination that the second user account and the third user account had previously established a connection, the communication platform may determine not to include the contact card information in the message.

At operation 314, based on a determination that the first group identifier is different from the second group identifier (e.g., no previous connection established between the second user and the third user), the communication platform causes a contact card 316 associated with the third user account to be presented in association with the communication 317 (e.g., communication 132). Additionally or alternatively, the communication platform can be configured to identify one or more user and/or organization preferences associated with the third user account, such as to determine if a user preference or an organization preference enables contact information sharing in association with the third user account. Based on a determination that the third user account (e.g., a user preference or organization preference associated therewith) does not permit contact information sharing, the communication platform may withhold contact information associated with the third user account from presentation in association with the communication 317. In some examples, the communication platform can cause the contact card 316 to be presented in association with the communication 317 based on a determination that the third user account permits contact information sharing.

In various examples, the communication platform can cause the presentation of the contact card 316 in association with the communication 317 via the first client 304 and a second client associated with the second user account. Though described as presenting the contact card 316 in association with a communication transmitted in a private message between the first user and the second user, this is not intended to be so limiting, and it is understood that the contact card may be transmitted in association with a communication transmitted between two or more people, such as in a multi-party direct message, a communication channel, workspace, board, or the like. In some examples, in response to determining that at least one member of the virtual space is not associated with the third user account, the communication platform can cause the contact card to be presented in association with the communication 317.

As discussed above, the communication platform can identify contact information to associate with the contact card 316 based on one or more of predetermined contact card criteria (e.g., established by the communication platform), a user preference, an organization preference, or the like. In the illustrative example, the contact card 316 includes a name, organization, and avatar associated with the third user account. In other examples, the contact card 316 can include additional or alternate contact information. In at least one example, the contact card 316 can include a first selectable control 318 to enable communications between the second user and the third user. In some examples, in response to receiving an indication of the first selectable control 318, the communication platform can cause a message composer interface (e.g., message composition interface) associated with a virtual space between the second user and the third user to be presented via a client of the second user.

In some examples, the contact card 316 can include a second selectable control 320 to enable the contact information associated with the third user to be stored in association with the contact list of the second user. In response to receiving an indication of selection of the second selectable control 320, the communication platform can cause the contact information to be stored in association with the second user account of the second user.

As discussed above, the communication platform can cause a presentation of the contact card 316 via a second client associated with the second user account of the second user. The second user can perform one or more functions with regard to the contact card 316 via the second client, as described with respect to the process 300B of FIG. 3B.

In some examples, the second user can select a third selectable control 321 to share the contact information associated with the third user with a fourth user, such as share contact selectable control 231. In response to receiving selection of the third selectable control 321, the communication platform can cause the contact information to be sent to a fourth user.

FIG. 3B is an example process 300B for enabling communications via a contact card presented in association with a communication that is transmitted via the communication platform, utilizing the techniques described herein. In some examples, some or all of process 300B may be performed by one or more components in the system 100. By way of example and not limitation, the communication platform referred to in process 300B may be representative of a computing device associated with the (communication platform) server(s) 102, the first user computing device referred to in process 300B may be representative of the user computing device(s) 104. However, the process 300B is not limited to being performed by the system 100.

At operation 322, the communication platform receives, from a second client 324 associated with the second user account, an indication of selection (e.g., selection) of the contact card 316 associated with the third user account and presented in association with the communication 325. In some examples, the communication 325 can include an instance of the communication 317 generated by the first user and transmitted via the communication platform. In some examples, the communication 325 can include the same or different data as that included in the communication 317. In some examples, the communication 325 can include the same data (e.g., first input 306), but presented in a different manner. In some examples, the communication platform may cause the presentation of the communication 325 and/or data associated therewith based on one or more user preferences and/or organization preferences associated with the second user account.

As discussed above with regard to FIGS. 1 and 2, the contact card 316 may itself be selectable (e.g., include a selectable control), such as to enable the second user to view a user profile associated with the third user, such as user profile 134. In some examples, the contact card 316 can include a first selectable control 318 to enable communications between the second user account and the third user account. In some examples, the contact card 316 can a second selectable control 320 to enable the contact information associated with the third user to be stored in association with the contact list of the second user.

At operation 326, in response to receiving a selection of the first selectable control, cause a message composer interface 328 associated with a second communication 330 to be presented via the second client 324. In various examples, the message composer interface 328 can additionally or alternatively be presented in response to receiving a selection of the contact card 316 itself. In such examples, the communication platform can be configured to cause the message composer interface 328 to be presented in response to any selection of the contact card 316. That is, in some examples, the contact card 316 can include a selectable control to enable communications between the second user and the third user (e.g., regardless of the presentation of, or interaction with, the first selectable control 318).

At operation 332, the communication platform receives, from the second client 324 and via the message composer interface 328, a request to transmit the second communication 330. In various examples, the request may be received in response to a selection of a send message selectable control 334 associated with the message composer interface 328.

At operation 336, the communication platform causes a notification 338 associated with the second communication 330 to be presented via a third client 340 associated with the third user account. In various examples, the notification 338 can include an indication that the second user has sent the second communication to the third user. In such examples, the notification 338 can include an indication of an “unread” message. In some examples, the notification 338 can include an indication that the second user requests to connect with the third user. In such examples, the notification 338 can include an indication of a “pending invitation” to connect with the second user. Although illustrated in association with a connect interface in a first sub-section of a sidebar pane or “first region” associated with the third client 340, this is not intended to be so limiting, and the notification 338 can be presented in additional or alternative sub-sections or regions associated with the third client 340, such as a sub-region associated with direct messaging instances, a second region associated with message feeds, and/or the like.

In some examples, the notification 338 can be presented in association with a connect interface 342. As briefly discussed above, the connect interface 342 can be associated with connections between the third user and one or more other users who are associated with organizations that are different from an organization of the third user. In some examples, the connect interface 342 may include one or more pages associated with invitations to connect (e.g., communications sent from other users with whom the third user has not previously communicated) and/or previous connections made with other users.

In various examples, the communication platform can cause a presentation of the connect interface 342 and/or the second communication 330 in response to receiving a selection of the notification 338. In some examples, the communication platform can cause a message composer interface 344 to be presented in association with the connect interface 342 and/or the second communication 330, such as in response to receiving an indication of selection of the notification 338. In some examples, the connect interface 342 and/or the message composer interface 344 can include one or more selectable controls 346. In the illustrative example, the selectable controls 346 include an option to accept the invitation to connect (e.g., enable communications with the second user), ignore the invitation to connect (e.g., delay responding to the second communication 330), and block the second user, though this is not intended to be so limiting and additional or alternative selectable controls 346 can be provided. In some examples, the communication platform can include a selectable link to the message that was sent by the third contact and a status of whether the invitation to connect with the third contact was accepted.

In response to receiving an indication of selection of an accept selectable control 346, the communication platform can cause a messaging instance to be generated between the second user and the third user. The messaging instance can include a direct messaging instance, a communication channel, a board, a workspace, or other virtual space that enables communications between the second user and the third user. In various examples, the communication platform can enable the second user and/or the third user to invite additional users to join the messaging instance. In some examples, the messaging instance may be a private messaging instance in which other users are not permitted to join.

In response to receiving an indication of selection of an ignore selectable control 346, the communication platform can store the second communication 330 in association with the third user account for a period of time. In some examples, the period of time can include a predetermined time associated with generating the messaging instance between the second user and the third user. As an illustrative example, the communication platform can store information associated with the second communication 330 (e.g., invitation to connect with the second user) for 5 days, 7 days, 14 days, or the like. In various examples, the communication platform can enable the third user to access the stored data associated with the second communication 330 during the period of time, such as via the connect interface 342. That is, the communication platform can enable the third user to respond (or not) to the invitation to connect at a later time within the period of time.

In some examples, after the period of time expires, the communication platform can cause a presentation of an indicator associated with the second communication. The indicator may include an indication that the second user invited the third user to communicate via the messaging instance, but that the invitation was ignored and has expired. In some examples, the communication platform can cause the indicator to be muted or otherwise disabled from enabling action associated therewith. That is, the indicator can merely provide information associated with the ignored invitation, but may no longer be selectable to generate the messaging instance.

In response to receiving an indication of selection of a block selectable control 346, the communication platform can disable an option to contact the second user. In some examples, the communication platform can additionally disable an option for the second user to contact the third user, such as by selecting a contact card associated therewith. In some examples, the communication platform can disable one or more selectable controls associated with the contact card 316. In some examples, the communication platform can store an indication of the block, such as to prevent additional or future attempts by the second user to contact the third user. For example, the communication platform may receive, at a time after receiving the selection of the block selectable control 346, a request to generate and/or transmit another communication to the third user account. In response to identifying that the third user had previously blocked the second user, the communication platform can cause a presentation of an error message via the second client, the error message indicating that communications with the third user are not authorized.

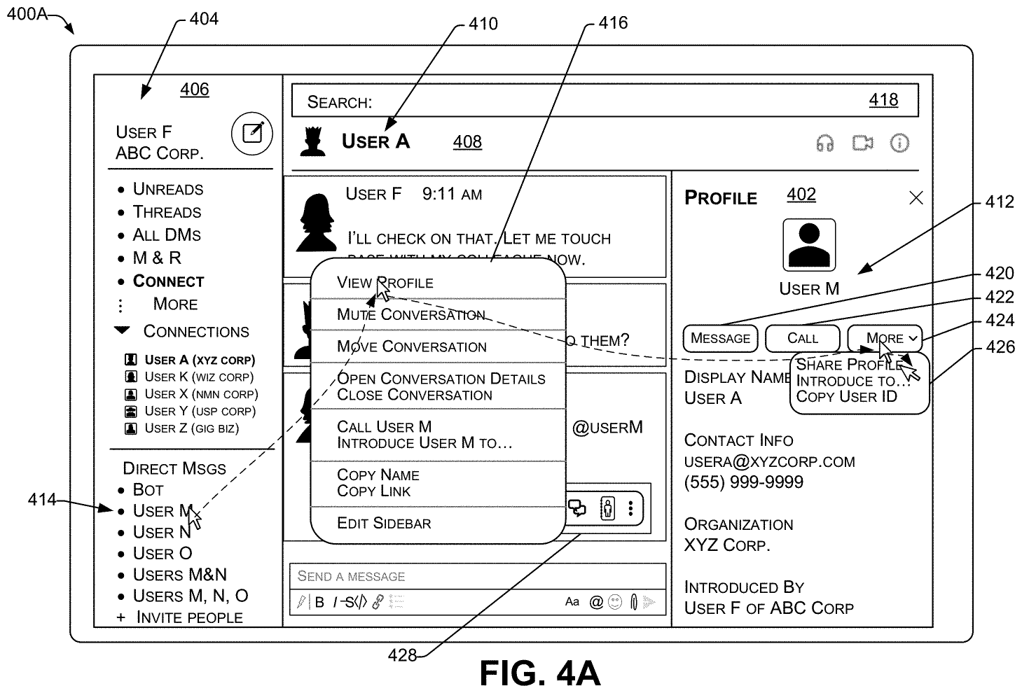

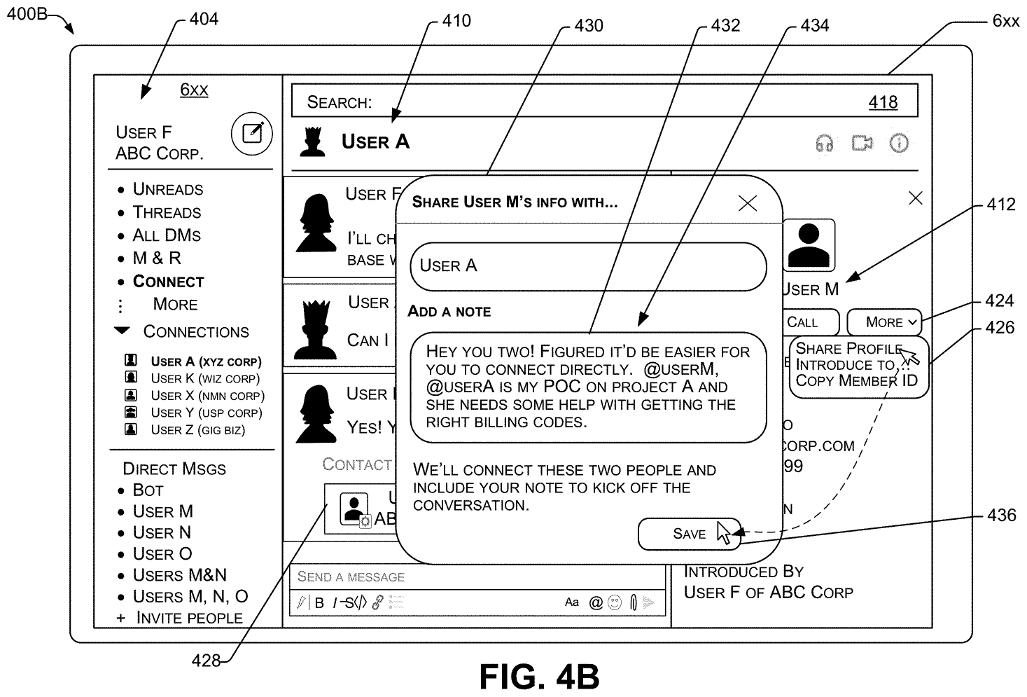

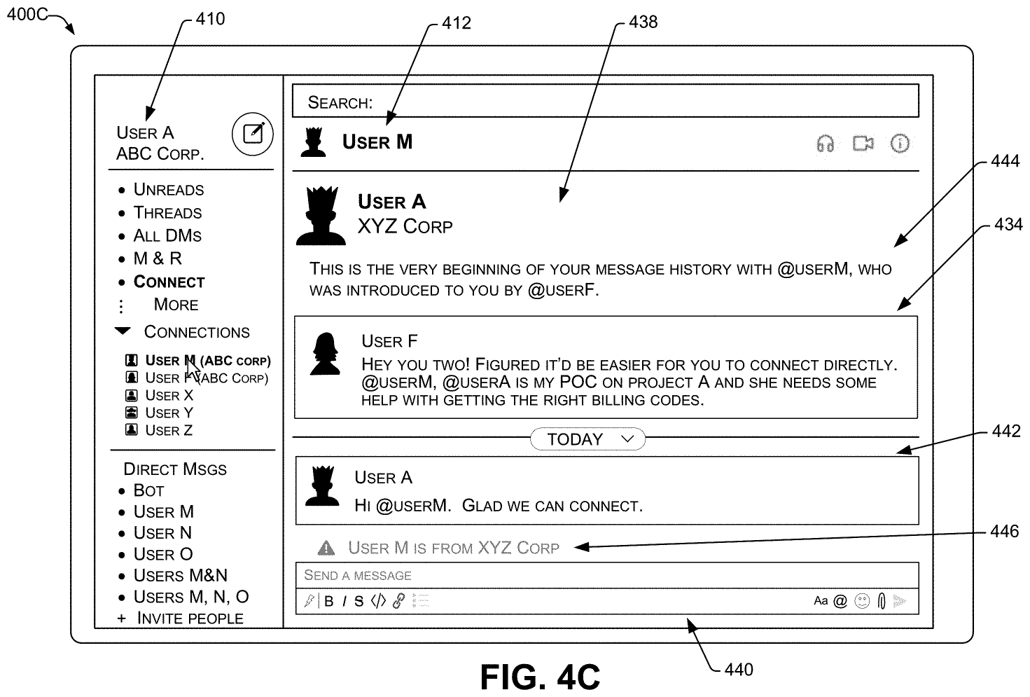

FIGS. 4A-4C illustrate example user interfaces associated with sharing contact information of a user with another user and providing an introductory communication to be presented in association with a virtual space between the user and the other user, utilizing the techniques described herein.

FIG. 4A illustrates an example user interface 400A, such as user interface 128, associated with sharing contact information via a user profile 402, such as user profile 134. In the illustrative example, the user interface 400A includes a first region 406, or pane, associated with one or more indicators that are selectable by a first user 404, such as to perform functions associated with the communication platform. The user interface 400A additionally includes a second region 408, or pane, associated with a messaging feed. Though illustrated as a message feed associated with a private message and/or direct messaging instance associated with a second user 410 (e.g., User A), this is not intended to be so limiting, and the second region 408 can include data associated with any other type of virtual space.

In various examples, the first user 404 intend to share contact information associated with a third user 412 with the second user 410, such as to connect the second user 410 and the third user 412. In some examples, the first user 404 can select an indicator 414 associated with the third user 412, such as one presented in the first region 406 of the user interface 400A. In some examples, the selection can include a right click or other means by which the communication platform identifies a request to access a menu 416 of actions that the first user 404 can perform with respect to the third user 412 and/or a connection associated therewith. Non-limiting examples of the actions include viewing the profile 402 of the third user 412, muting a conversation associated with the indicator 414, moving the conversation to another location (e.g., not associated with direct messaging instances), opening conversation details (e.g., date/time associated with a last communication transmitted in the conversation, frequency of communications, etc.), closing the conversation (e.g., ending further transmissions associated with the conversation), calling the third user 412, introducing the third user 412 to another user, copying a name (e.g., username, real name, etc.), copying a link associated with the third user 412, and/or the conversation, and editing the sidebar (e.g., moving a position of the indicator 414 or other indicators). In various examples, and as described above, the contact card 428 can include a means by which the second user 410 can share the contact information associated with the third user 412 with a fourth user, such as in association with another communication. In such examples, the contact card 428 can include a share contact selectable control, such as share contact selectable control 231, share contact selectable control 321, etc.

Additionally or alternatively, the first user 404 can access the menu 416 by searching for and selecting the third user 412 via a search mechanism 418. In such examples, the first user 404 can input an identifier associated with the third user 412 into the search mechanism 418, and can select an option to view the menu 416 associated with an identifier of the third user 412 presented in association with the search mechanism 418.

In some examples, the communication platform can enable sharing of contact information associated with the third user 412 in response to receiving an indication of selection of an introduction option associated with the menu 416. For example, in response to receiving an indication of selection of a “introduce user M to” option associated with the menu 416, the communication platform can cause a contact card, such as contact card 130 and/or contact card 316, to be presented in association with a communication associated with a messaging instance that is currently active in the second region (e.g., the messaging instance between the first user 404 and the second user 410).

In the illustrative example, the first user 404 selects a view profile selectable control associated with the menu 416. In such an example, in response to receiving the selection of the view profile selectable control, the communication platform causes the user profile 402 to be presented via the user interface 400A. In the illustrative example, the user profile 402 is presented in the second region 408. In other examples, the user profile 402 can be presented in another region of the user interface 400A, in a window, or other viewing option associated with the user interface 400A.

In various examples, the user profile 402 can include information associated with the third user 412. The information can include user data (e.g., username, real name, social networking handle, user identifier, time zone, working location, demographic data, education, qualifications, etc.), employment data (e.g., organization, job title, job position, manager(s), etc.), contact information (e.g., telephone number, email address, physical address (e.g., city, state, country, etc.), etc.), user interests (e.g., hobbies, favorite sports teams, etc.). In various examples, the communication platform may identify information to include in the user profile 402 based on user preferences and/or organization preferences associated with user profiles. For example, an organization of the user can establish an organization preference to share a first set of information about members of the organization via user profiles. For another example, the third user 412 can establish a user preference associated with particular information to be made available via the user profile 402.

In some examples, the user profile 402 can include a message selectable control 420, such as message selectable control 222, configured to facilitate communications between the first user 404 and the third user 412. In response to receiving a selection of the message selectable control 420, the communication platform can cause a presentation of (e.g., launch) a messaging instances between the first user 404 and the third user 412. The messaging instance can be an existing messaging instance, such as if one was previously generated, or a new messaging instance, such as if the first user 404 and the third user 412 had not previously communicated via a private messaging instance (e.g., private direct messaging instance).

In some examples, the user profile 402 can include a call user selectable control 422, configured to facilitate audio and/or video communications between the first user 404 and the third user 412. In response to receiving a selection of the call user selectable control 422, the communication platform can generate an audio and/or video conversation (e.g., a call) from the first user 404 to the third user 412. In various examples, the user profile 402 can include a more options selectable control 424, configured to enable the first user 404 to identify and select different available actions to perform with respect to the user profile 402. In response to receiving a selection of the more options selectable control 424, the communication platform can cause a more options menu 426 to be presented in association with the user interface. In some examples, the more options menu 426 can include a drop down menu associated with the more options selectable control 424. In other examples, the more options menu 426 can be presented in a window independent of the more options selectable control 424, or another viewing interface associated with the user profile 402 and/or user interface 400A.

In the illustrative example, the more options menu 426 includes a first option to share the user profile 402, a second option to introduce the third user 412 to another user, and a third option to copy the user identifier associated with the third user 412. Though this is not intended to be so limiting and additional or alternative options are contemplated herein. In various examples, in response to receiving an indication of selection of the second option, the communication platform can cause a message composer interface to be presented via the user interface 400A, such as in a window or other viewing interface. In some examples, the message composer interface can enable the first user 404 to send a message or other introduction to the third user 412, such as to introduce the third user 412 to another user (e.g., the second user 410).

In some examples, in response to receiving an indication of selection of the first option to share the user profile 402, the communication platform can cause a presentation of a contact card 428 associated with the third user 412, such as contact card 130 and/or contact card 316, to be presented in associated with a communication between the first user 404 and the second user 410. In various examples, in response to receiving an indication of selection of the first option to share the user profile 402, the communication platform can cause a share contact confirmation window to be presented in association with the user interface 400A.

FIG. 4B illustrates an example user interface 400B in which a share contact confirmation window 430, such as share contact confirmation window 310, is presented, such as in response to a selection of an option to share the user profile 402. In various examples, the share contact confirmation window 430 can include an option to confirm a share of the contact information associated with the third user 412, such as that described above with respect to FIG. 3A.

In some examples, the share contact confirmation window 430 can include an introductory message input section 432 via which the first user 404 can draft an introductory message 434 to include in a messaging instance between the second user 410 and the third user 412. In such examples, the communication platform can enable the first user 404 to broker a connection between (e.g., introduce) the second user 410 and the third user 412, such as by providing context associated with why the first user 404 is sharing the contact information of the third user 412. In some examples, in response to receiving an indication of selection of a save selectable control 436, the communication platform may store the introductory message 434 in association with the contact card 428. In such examples, in response to receiving an indication of selection of the contact card 428 and/or a messaging selectable control associated therewith (e.g., messaging selectable control 230, first selectable control 318, etc.), the communication platform can cause the introductory message 434 to be presented in a messaging instance between the second user 410 and the third user 412.

FIG. 4C illustrates an example user interface 400C associated with a second user account of the second user 410 in which a messaging interface 438 associated with communications between the second user 410 and the third user 412 is presented. As discussed above, the messaging interface 438 can be presented via the user interface 400C in response to a selection, by the second user 410, of the contact card 428 presented in association with the messaging instance between the first user 404 and the second user 410. That is, the communication platform can cause the messaging interface 438 to be presented in response to receiving an indication of selection of the contact card 428 and/or a messaging selectable control associated therewith.

In various examples, the messaging interface 438 can include a message composer interface 440 via which the second user 410 can compose a message 442 (e.g., a communication) to the third user 412. In some examples, the messaging interface 438 can include the introductory message 434, generated by the first user 404, as described above with regard to FIG. 4B. In at least one example, the messaging interface 438 can include details 444 associated with the messaging interface 438. The details 444 can include a date and/or time in which the second user initiated the messaging interface 438, an indication of the first user 404 associated with making the introduction, and/or any other details associated with the messaging interface 438 and/or the third user 412.

In some examples, the messaging interface 438 can include a warning 446 indicating that the third user 412 is associated with an organization that is different from another organization of the second user 410. In such examples, the warning 446 may assist in preventing the second user 410 from sharing sensitive information with the third user 412.

In various examples, in response to receiving an indication of acceptance of the messaging interface 438, such as from the third user 412, the communication platform can generate a messaging instance that enables continued communications between the second user 410 and the third user 412.

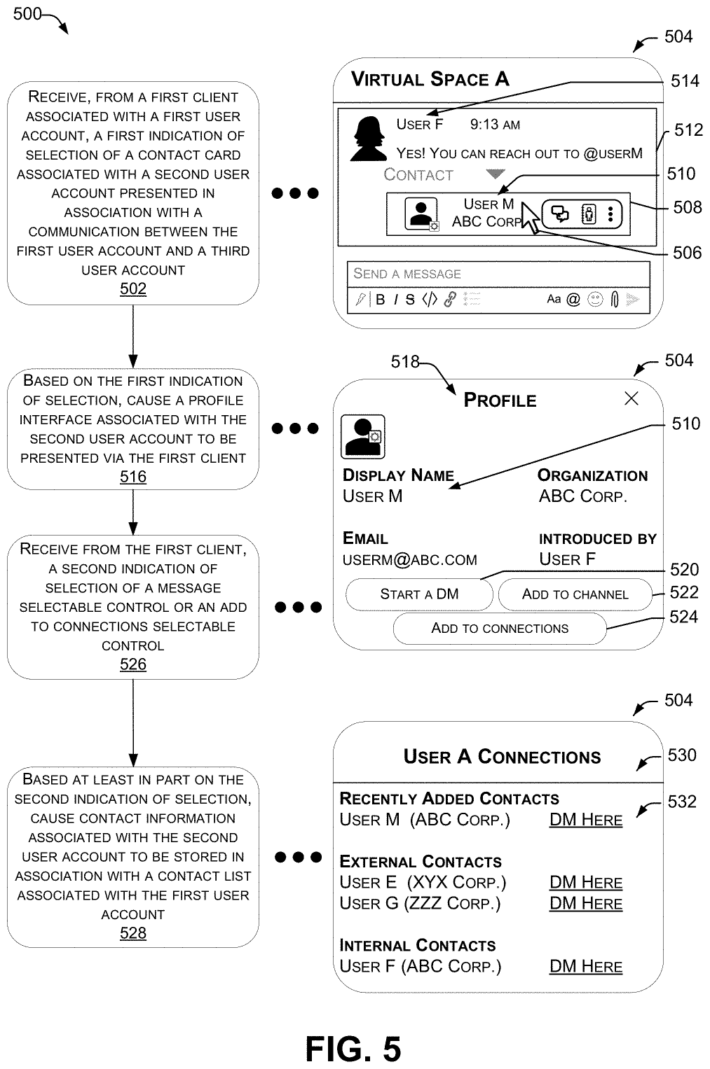

FIG. 5 illustrates an example process for updating a contact list of a user based on a selection of a contact card associated with another user that is transmitted via a communication platform, utilizing the techniques described herein. In some examples, some or all of process 500 may be performed by one or more components in the system 100. By way of example and not limitation, the communication platform referred to in process 500 may be representative of a computing device associated with the (communication platform) server(s) 102, the first user computing device referred to in process 500 may be representative of the user computing device(s) 104. However, the process 500 is not limited to being performed by the system 100.

At operation 502, the communication platform receives, from a first client 504 associated with a first user account of a first user 506 (illustrated as a cursor), a first indication of selection (e.g., first selection) of a contact card 508 (e.g., contact card 130, contact card 316, contact card 428, etc.) associated with a second user account of a second user 510 presented in association with a communication 512 between the first user account and a third user account of a third user 514.

In various examples, the communication 512 can be associated with a virtual space (e.g., Virtual Space A) in which the first user 506 and the third user 514 are members. The virtual space can include a direct messaging instance, a communication channel, a thread associated with a communication channel, a workspace, a board, and/or any other type of virtual space provided by the communication platform. In some examples, the virtual space can include a private virtual space between the first user 506 and the third user 514. In such examples, the communication platform can cause the contact card 508 to be presented in association with the communication 512, in response to a request, from the third user 514 to introduce the second user 510 to the first user 506 (e.g., a request to associate contact information of the second user 510 with the communication 512). As described above, the communication platform can, based on the request from the third user 514, determine whether a previous connection between the first user 506 and the second user 510 had been established (e.g., first user 506 and the second user 510 associated with a same organization, contact information of the second user 510 associated with a contact list of the first user 506, etc.). Based on a determination that a connection between the first user 506 and the second user 510 had not previously been established (e.g., no connection between the users exists), the communication platform can cause the contact card 508 to be presented in association with the communication 512 transmitted via the virtual space.

In some examples, the virtual space can include a public virtual space in which the first user 506 and third user 514 are both members. In such examples, based on a determination that at least the first user 506 (and/or other members of the virtual space) is not associated with a same organization as the second user 510, the communication platform can cause the contact card 508 to be presented in association with the communication 512 transmitted via the virtual space.

At operation 516, based on the first indication of selection, the communication platform causes a user profile 518, such as user profile 134 and/or user profile 402, associated with the second user account to be presented via the first client 504. The user profile 518 can include information associated with the second user 510. The information can include user data (e.g., username, real name, social networking handle, user identifier, time zone, working location, demographic data, education, qualifications, etc.), employment data (e.g., organization, job title, job position, manager(s), etc.), contact information (e.g., telephone number, email address, physical address (e.g., city, state, country, etc.), etc.), user interests (e.g., hobbies, favorite sports teams, etc.). In various examples, the communication platform may identify information to include in the user profile 518 based on user preferences and/or organization preferences associated with user profiles. For example, an organization of the user can establish an organization preference to share a first set of information about members of the organization via user profiles. For another example, the second user 510 can establish a user preference associated with particular information to be made available via the user profile 518.

In some examples, the user profile 518 can include a message selectable control 520, such as message selectable control 222 and/or message selectable control 420, configured to facilitate communications between the first user 506 and the second user 510. In response to receiving a selection of the message selectable control 520, the communication platform can cause a presentation of (e.g., launch) a message composer interface to be presented via the first client 504. The message composer interface can be associated with new messaging instance between the first user 506 and the second user 510.

In some examples, the user profile 518 can include an add to channel selectable control 522, such as add channel selectable control 224, configured to facilitate sending an invitation to the second user 510 to join a particular communication channel. In various examples, in response to receiving an indication of selection of the add to channel selectable control 522, the communication platform may request additional information from the first user 506, such as to specify a channel to which the second user 510 will be invited. In response to receiving the additional information, the communication platform can send an invitation to the second user 510 to join the channel and/or automatically associate the second user 510 with the channel. In various examples, the communication platform can determine whether to send the invitation or automatically associate the second user 510 based on a user preference and/or organization preference associated with the second user 510 and/or an owner or administrator of the channel. Though illustrated and described as a selectable control to add the second user 510 to a channel, this is not intended to be so limiting, and the add to channel selectable control 522 can include an option to add the second user 510 to additional or alternative virtual spaces, such as a workspace, an audio or video conversation, a board, or the like.

In some examples, the user profile 518 can include an add to connections selectable control 524, such as add to connections selectable control 226. In some examples, in response to receiving an indication of selection of the add to connections selectable control 524, the communication platform can include data associated with the second user 510 to be presented via the first client 504, such as in association with a connect interface (e.g., connect interface 342). In such examples, the first user 506 can initiate a connection (e.g., send a message) to the second user 510 by selecting an indicator associated with the second user 510, such as connection indicator 208. In some examples, in response to receiving an indication of selection of the add to connections selectable control 524, the communication platform can include data associated with the second user 510 in a contact list (e.g., directory, address book, etc.) of the first user 506. That is, the add to connections selectable control 524 can enable the first user 506 to store contact information associated with the second user 510, such as for generating and sending a message to the second user 510 at a later time and/or not in association with the contact card 508.

At operation 526, the communication platform receives, from the first client, a second indication of selection of a message selectable control 520 or a add to connections selectable control 524. Based at least in part on the second indication of selection, the communication channel, at operation 528, causes contact information associated with the second user 510 to be stored in association with a contact list 530 associated with the first user account. In various examples, the contact list 530 includes contact information associated with other users of the communication platform. In some examples, the contact list 530 includes contact information associated with users with whom the first user 506 has previously established a connection (e.g., shares an organization with, has communicated with, etc.). In some examples, the contact list 530 includes contact information associated with users with whom the first user 506 has not established a connection, but has caused contact information associated therewith to be stored, such as by selecting an option to store contact information in association with a contact card 508.

In various examples, the contact list 530 can be stored in a datastore of the communication platform, such as datastore 122. In some examples, the contact list 530 can be accessible to the first user 506, such as via the first client 504. In such examples, the communication platform can configure the contact list 530 for interaction by first user 506. In some examples, the contact list 530 can include a message selectable control 532, such as message selectable control 520, associated with one or more contacts included in the contact list 530. In some examples, the message selectable control 532 can provide a quick and efficient means by which the first user 506 can access and/or generate a messaging instance between a contact associated with the contact list 530.

In the illustrative example, the contact list 530 includes a recently added contacts section, an external contacts section, and an internal contacts section. In such an example, the contacts associated with the contact list 530 can be organized based on the section. For example, based on a determination that the second indication of selection of the message selectable control 520 or the add to connections selectable control 524 was received within a threshold time period, the communication platform can cause data associated with the second user to be presented in the recently added contacts section. For example, based on a determination that a time associated with the second indication of selection of the message selectable control 520 or the add to connections selectable control 524 meets or exceeds the threshold time period, the communication platform can cause data associated with the second user 510 to be presented in the external contacts section. In some examples, the internal contacts section can include contacts of the first user 506 that are associated with a same organization as the first user.

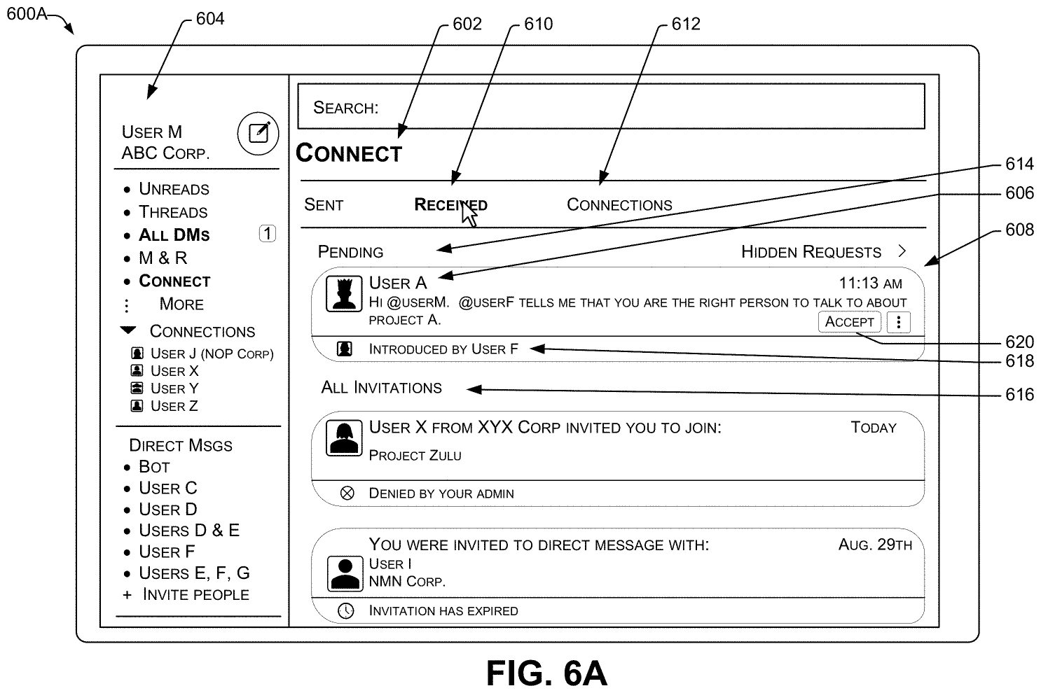

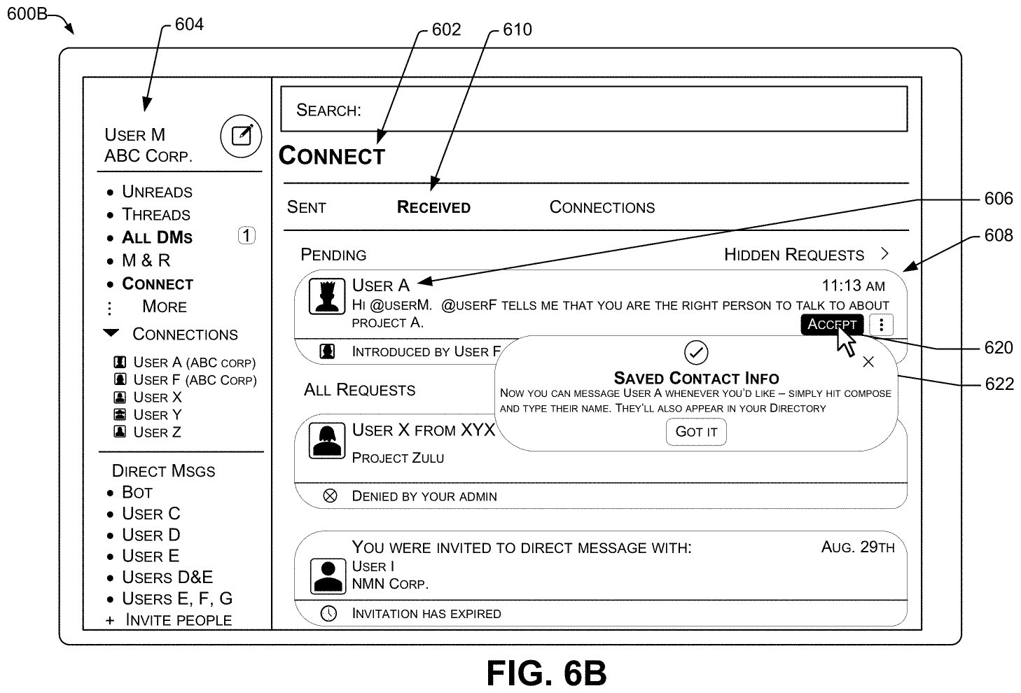

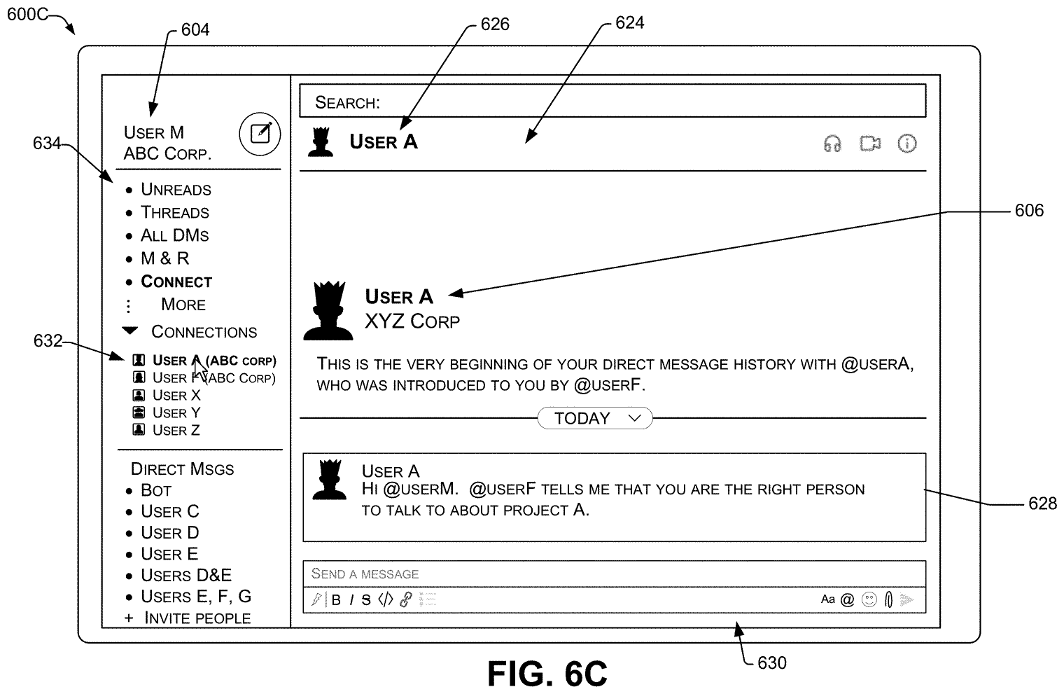

FIGS. 6A-6C illustrate example user interfaces associated with receiving an invitation to connect via the communication platform and generating a virtual space in response to an acceptance thereof, utilizing the techniques described herein. The interface 600A of FIG. 6A includes a connect interface 602, such as connect interface 342, associated with a user account of a user 604 (e.g., User M). As discussed above, the user 604 can include the recipient of an invitation to communicate (or connect) with another user 606 (e.g., User A) generated in association with a contact card, such as described above with regard to at least FIGS. 3A, 3B and 4A-4C. That is, the user 604 can be the third user associated with the contact card presented in association with a communication and selected, such as to send a communication thereto (e.g., invitation to communicate). As described above with regard to FIG. 3B, in some examples, the invitation to communicate can include one or more selectable controls configured to enable the user 604 to accept, ignore, or block communications from the other user 606.

In various examples, in response to receiving, from a client associated with the other user 606, a selection of a send message selectable control (e.g., send message selectable control 334) associated with the communication including the invitation to connect, the communication platform can present an invitation to connect 608 via the connect interface 602. In some examples, the invitation to connect 608 can be presented in association with a received invitations page 610 of the connect interface. In other examples, the invitation to connect 608 can be presented in additional or alternative pages, such as a connections page 612 or the like.

In the illustrative example, the received invitations page 610 can include a pending invitations section 614 including one or more pending invitations, such as the invitation to connect 608. The pending invitation(s) can include invitations to connect that are still active (e.g., time period associated therewith has not expired) and that the user 604 has not yet responded (e.g., has not accepted, ignored, denied, blocked, etc.). In some examples, the received invitations page 610 can include an all invitations section 616 including one or more invitations sent to the user 604. The invitation(s) can include pending invitations, such as invitation to connect 608, invitations that have been denied (e.g., such as by the user 604, an administrative user associated with an organization of the user 604, or the like), expired invitations (e.g., invitations not responded to or ignored), and/or accepted invitations. In some examples, the accepted invitations can additionally or alternatively be included in the connections page 612, which can include one or more indicators associated with established connections with users associated with an organization that is different from an organization of the user 604.

In some examples, the invitation to connect 608 can include an indication of introduction 618. In some examples, the invitation to connect 608 can include an indication of an acceptance once accepted or declined, if not accepted. The indication of introduction 618 can provide an indication of the user who shared contact information of the user 604 with the other user 606, such as in a contact card associated with a communication. In some examples, the invitation to connect 608 can include an introductory message composed by the user who shared the contact information, such as that described above with regard to FIG. 4B. In various examples, the invitation to connect 608 can include a message generated by the other user 606 and directed to the user 604.

In various examples, the invitation to connect 608 can include an accept selectable control 620 that enables the user 604 to accept the invitation to connect 608. That is, in response to receiving an indication of selection the accept selectable control 620 the communication platform can establish a connection between the user 604 and the other user 606. In some examples, in response to receiving the indication of selection of the accept selectable control 620, the communication platform can cause a messaging instance to be generated between the user 604 and the other user 606. In various examples, the messaging instance can include the message and/or the introductory message described above.

The interface 600B of FIG. 6B includes the received invitations page 610 of the connect interface 602, in which the user 604 selects the accept selectable control 620 associated with the invitation to connect 608. In some examples, in response to receiving an indication of selection of the accept selectable control 620, the communication platform can store contact information associated with the other user 606 in a contact list or directory of the user 604.

In various examples, in response to receiving the indication of selection of the accept selectable control 620, the communication platform can cause a presentation of an information window 622, providing information to the user 604 about actions taken by the communication platform in response to receiving an indication of selection of the accept selectable control 620. In the illustrative example, the information window 622 provides an indication that the contact information associated with the other user 606 is saved in a contact list (or directory) of the user 604. In other examples, the information window 622 can include additional or alternative information, such as an indication of the messaging instance generated, mutual contacts associated with both the user 604 and the other user 606, a number of contacts of the other user 606, and/or the like. The information window 622 can be configured to be acknowledged, such as with a selection of a “GOT IT” selectable control, or ignored, such as by closing the information window 622 (e.g., selecting the X).

As discussed above, in response to receiving the selection of the accept selectable control 620, the communication platform can generate a virtual space to facilitate communications between the user 604 and the other user 606.

The interface 600C of FIG. 6C illustrates a messaging interface 624 associated with a virtual space 626 generated in response to a selection, by the user 604, of the accept selectable control 620 described above. In some examples, the virtual space 626 can include a private messaging instance (e.g., direct messaging instance) between the user 604 and the other user 606. In some examples, the virtual space 626 can include a communication channel, a workspace, a board, or other virtual space configured to facilitate communications between two or more users.

In various examples, the communication platform can cause a message 628 to be presented via the messaging interface 624. In the illustrative example, the message 628 includes the message generated by the other user 606, such as in a greeting to associate the invitation to connect 608. In other examples, the messaging interface 624 can additionally or alternatively include an introductory message generated by the introducing user (e.g., User F). The messaging interface 624 can additionally include a message composer interface 630, enabling the user 604 to compose and send messages to the other user 606 via the virtual space 626.

In various examples, the communication platform can modify a sidebar 634 of the interface 600 to include a connection indicator 632, such as connection indicator 208. In the illustrative example, the connection indicator 632 is presented in association with a list of connections of the user 604 provided in the sidebar 634 (e.g., sidebar pane). The list of connections can include external contacts of the user 604, virtual spaces that include at least one external contact, common or frequently accessed contacts or virtual spaces associated therewith, and/or the like. Though illustrated in association with the list of connections, this is not intended to be so limiting, and the connection indicator 632 can be presented in additional or alternative sub-sections, such as in a sub-section associated with direct messaging instances, a sub-section associated with communication channels, and/or a sub-section associated with any other type of virtual space.

In some examples, the communication platform can cause the messaging interface 624 to be presented via the interface 600 in response to receiving an indication of selection of the accept selectable control 620. In some examples, in response to receiving an indication of selection or the accept selectable control 620, the communication platform can automatically modify the sidebar 634 to include the connection indicator 632. In such examples, the communication platform can cause the messaging interface 624 to be presented in response to receiving an indication of selection of the connection indicator 632.

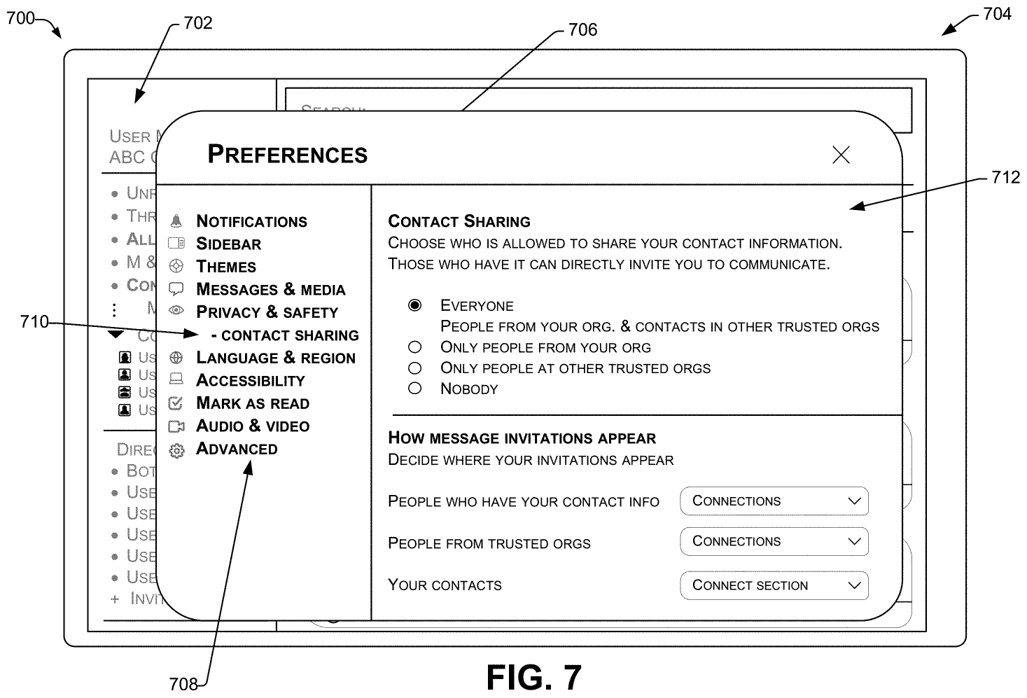

FIG. 7 illustrates an example user interface 700 associated with establishing user preferences associated with enabling contact information sharing. In various examples, in response to receiving, from a user 702 via the user interface 700 associated with a client 704, a request to set or update user preferences, such as in association with a user profile, the communication platform can cause a presentation of a preferences window 706 to be presented in association with the user interface 700.

In various examples, the preferences window 706 can include an options menu 708 including a list of selectable options available to the user 702 to modify with respect to a user account thereof. Non-limiting examples of the options include notifications (e.g., types, presentation, etc.), sidebar (e.g., presentation and/or order of items in a sidebar, type and/or order of sub-sections included in the sidebar, etc.), themes, messages and media (e.g., a presentation of messages and other media), privacy and safety, language and region, accessibility (e.g., functions for users with impairments, etc.), mark as read settings, audio and video settings, and advanced settings.

In the illustrative example, the user 702 can access preferences associated with contact sharing (e.g., contact sharing option 710) through a privacy and safety option of the options menu 708. In other examples, the contact sharing option 710 can be accessible as a stand-alone option (e.g., not associated with the privacy and safety option, and/or it can be associated with an additional or alternative option of the options menu 708. In some examples, in response to receiving an indication of selection of the contact sharing option 710, the communication platform can cause a contact sharing page 712 to be presented in the preferences window 706.

In some examples, the contact sharing page 712 can include an option to select other users who are authorized to share contact information of the user 702, such as in a contact card associated therewith (e.g., contact card 130, contact card 316, contact card 428, etc.). In some examples, the user 702 can authorize users associated with an organization of the user 702 and/or contacts associated with other trusted organizations to share the contact information. In some examples, a trusted organization can include an organization that has been vetted by an administrative user of an organization of the user 702 and/or an organization including at least one member who is connected to at least one member of the organization of the user 702. In some examples, the user 702 can select an option to not authorize any other users to share the contact information (e.g., selection of a “NOBODY” option).

In various examples, the contact sharing page 712 can include an option to select where invitations to connect, such as invitation to connect 608, appear with respect to a user interface 700. In some examples, the contact sharing page 712 can include different options associated with different people. For example, the contact sharing page 712 can include a first option to designate a location for invitations associated with other users who have the contact information of the user 702, a second option to designate a location for invitations associated with users from trusted organizations, and a third option to designate a location for invitations associated with users who are contacts of the user 702. Though this is not intended to be so limiting, and the contact sharing page 712 can include additional or alternative options, such as designating a location for invitations associated with people who are introduced by select people (e.g., close contacts, co-workers, friends, family, etc.).

FIGS. 3A-3B, 5, and 8-12 illustrate example processes in accordance with embodiments of the disclosure. These processes are illustrated as logical flow graphs, each operation of which represents a sequence of operations that may be implemented in hardware, software, or a combination thereof. In the context of software, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described operations may be combined in any order and/or in parallel to implement the processes.

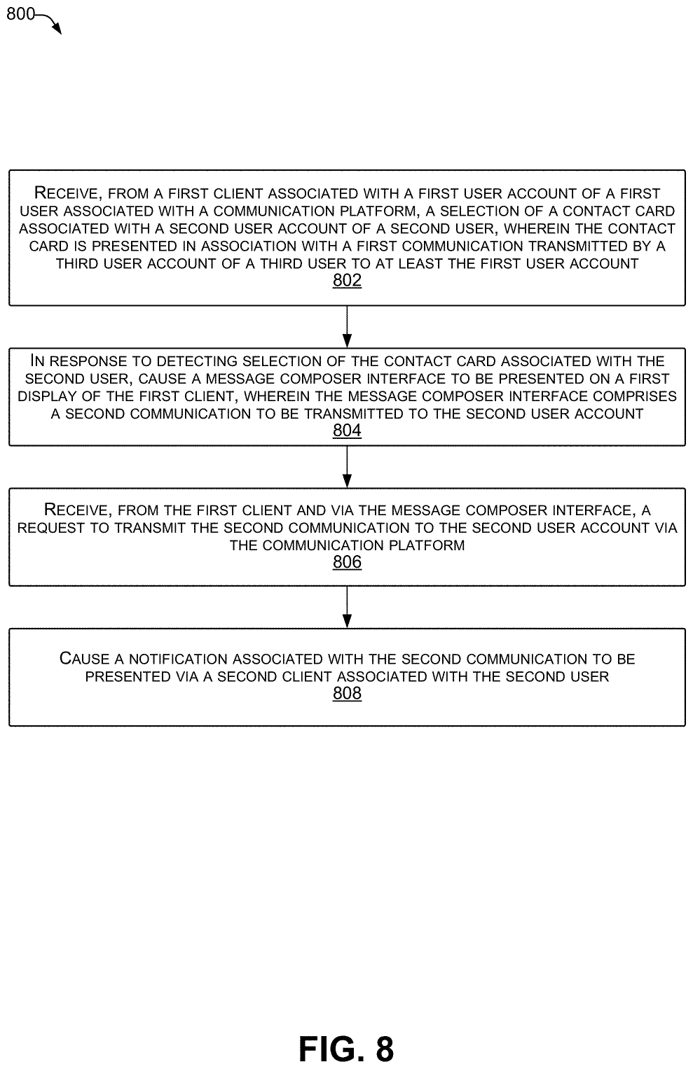

FIG. 8 illustrates an example process 800 for enabling communications between two previously unconnected users via a contact card shared by a third user, utilizing the techniques described herein. In some examples, some or all of process 800 may be performed by one or more components in the system 100. By way of example and not limitation, the communication platform referred to in process 800 may be representative of a computing device associated with the (communication platform) server(s) 102, the first user computing device referred to in process 800 may be representative of the user computing device(s) 104. However, the process 800 is not limited to being performed by the system 100.

At operation 802, the communication platform receives, from a first client associated with a first user account of a first user associated with the communication platform, a selection of a contact card associated with a second user account of a second user, wherein the contact card is presented in association with a first communication transmitted by a third user account of a third user to at least the first user account. As discussed above, the communication platform can associate the contact card with the first communication in response to receiving an input, in association with the third user account, of an identifier associated with the second user. In at least one example, the identifier can include a mention of the second user, such as a symbol (e.g., @, $, \hat{ }, #, *, &, etc.) in association with a username, real name, user ID, and/or the like associated with a second user. In at least one example, the mention can include an @mention of the second user. For example, the third user can include @seconduser in the text of the first communication. Though this is not intended to be so limiting, and additional or alternative symbols are contemplated herein.

At operation 804, in response to detecting selection of the contact card associated with the second user, the communication platform causes a message composer interface, such as message composer interface 328, message composer interface 344, message composer interface 440, message composer interface 630, and/or the like, to be presented on a first display of the first client, wherein the message composer interface comprises a second communication to be transmitted to the second user account. In various examples, the message composer interface can enable the first user to compose and transmit the second communication to the second user account.

At operation 806, the communication platform receives, from the first client and via the message composer interface, a request to transmit the second communication to the second user account via the communication platform. In various examples, the request may be received in response to a selection of a send message selectable control, such as send message selectable control 334.

At operation 808, the communication platform causes a notification associated with the second communication to be presented via a second client associated with the second user. In various examples, the notification can include an indication that the first user has sent the second communication to the second user. In such examples, the notification can include an indication of an “unread” message. In some examples, the notification can include an indication that the first user requests to connect with the second user. In such examples, the notification can include an indication of a “pending invitation” to connect with the first user, such as in a connect interface.

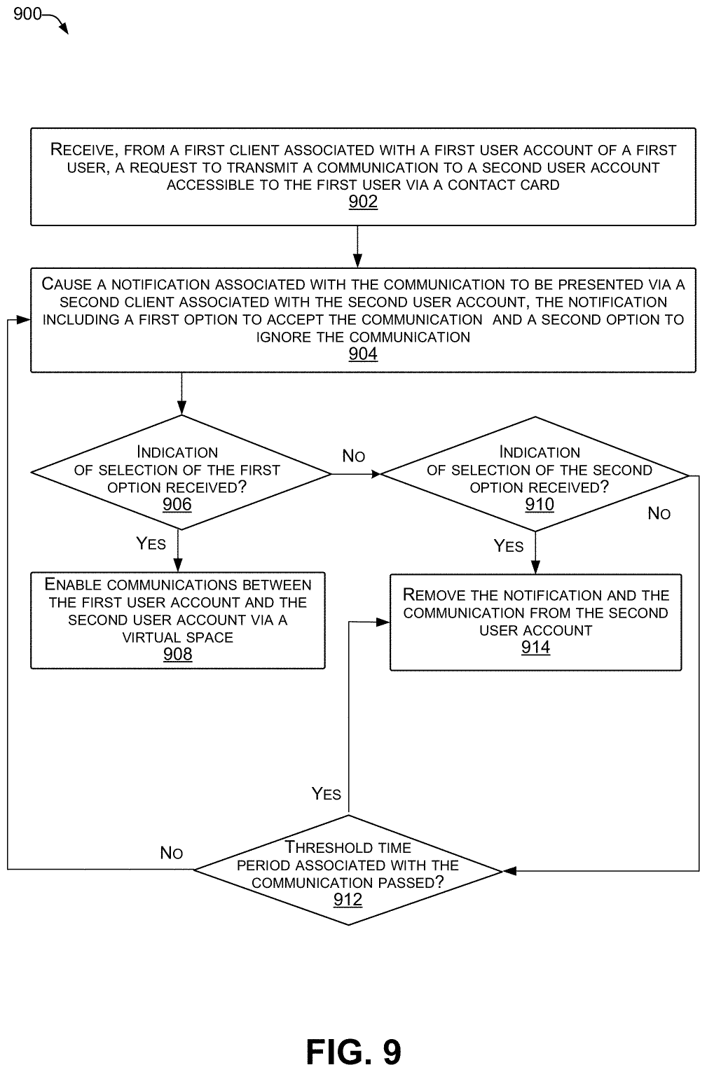

FIG. 9 illustrates an example process 900 for establishing communications between two previously unconnected users in response to receiving an indication of selection of an option to communicate, utilizing the techniques described herein. In some examples, some or all of process 900 may be performed by one or more components in the system 100. By way of example and not limitation, the communication platform referred to in process 900 may be representative of a computing device associated with the (communication platform) server(s) 102, the first user computing device referred to in process 900 may be representative of the user computing device(s) 104. However, the process 900 is not limited to being performed by the system 100.

At operation 902, the communication platform receives, from a first client associated with a first user account of a first user, a request to transmit a communication to the second user account accessible to the first user via a contact card. As discussed above, in various examples, a third user can provide the contact card to the first user, such as in association with another communication. In such examples, in response to receiving an input associated with an identifier or a mention of the second user in the other communication between the first user and the third user, the communication platform can cause a presentation of (e.g., unfurl) the contact card.

In various examples, in response to receiving a selection, by the first user, of the contact card, the communication platform can cause a presentation of a message composer interface (e.g., message composer interface 328, message composer interface 344, message composer interface 440, message composer interface 630, etc.). In some examples, the request to transmit the communication can be received via the message composer interface, such as by selection of a send message selectable control, such as send message selectable control 334.

At operation 904, the communication platform causes a notification associated with the communication to be presented via a second client associated with the second user account, the notification including a first option to accept the communication and a second option to ignore the communication. In various examples, the notification can include an indication that the first user has sent the second communication to the second user. In such examples, the notification can include an indication of an “unread” message. In some examples, the notification can include an indication that the first user requests to connect with the second user. In such examples, the notification can include an indication of a “pending invitation” to connect with the first user, such as in a connect interface.

At operation 906, the communication platform determines whether an indication of selection of the first option is received (e.g., selection of the first option is detected). Based on a determination that the indication of selection of the first option is received (“Yes” at operation 906), the communication platform, at operation 908, enables communications between the first user account and the second user account via a virtual space. The virtual space can include a direct messaging instance, a communication channel, a thread associated with a communication channel, a workspace, a board, and/or any other type of virtual space provided by the communication platform. In some examples, in response to receiving the indication of selection of the first option (e.g., accepting the communication), the communication platform generates the virtual space. In such examples, the communication platform can associate identifiers associated with at least the first user account and the second user account with the virtual space.

Based on a determination that the indication of selection of the first option is not received (“No” at operation 906), the communication platform, at operation 910, determines whether an indication of selection of the second option is received. Based on a determination that the indication of selection of the second option is not received (“No” at operation 910), the communication platform, at operation 912, determines whether a threshold time period associated with the communication has passed. In various examples, the threshold time period can include a threshold amount of time associated with an invitation to connect that is sent in association with a contact card. That is, the communication platform can be configured to present notifications (e.g., indicators associated with invitations to connect) for a designated period of time after delivery (e.g., one week, 10 days, 14 days, etc.).

Based on a determination that the threshold time period associated with the communication has not passed (“No” at operation 912), the communication platform causes the notification associated with the communication to be presented via the second client, as described with regard to operation 904. Based on a determination that the threshold time period associated with the communication has passed (“Yes” at operation 912) and/or that the indication of selection of the second option is received (“Yes” at operation 910), the communication platform, at operation 914, removes the notification and the communication from the second user account. That is, the communication platform can delete or otherwise remove, from the second user account, indicators associated with the notification, the communication, and/or an invitation to connect received from the first user.

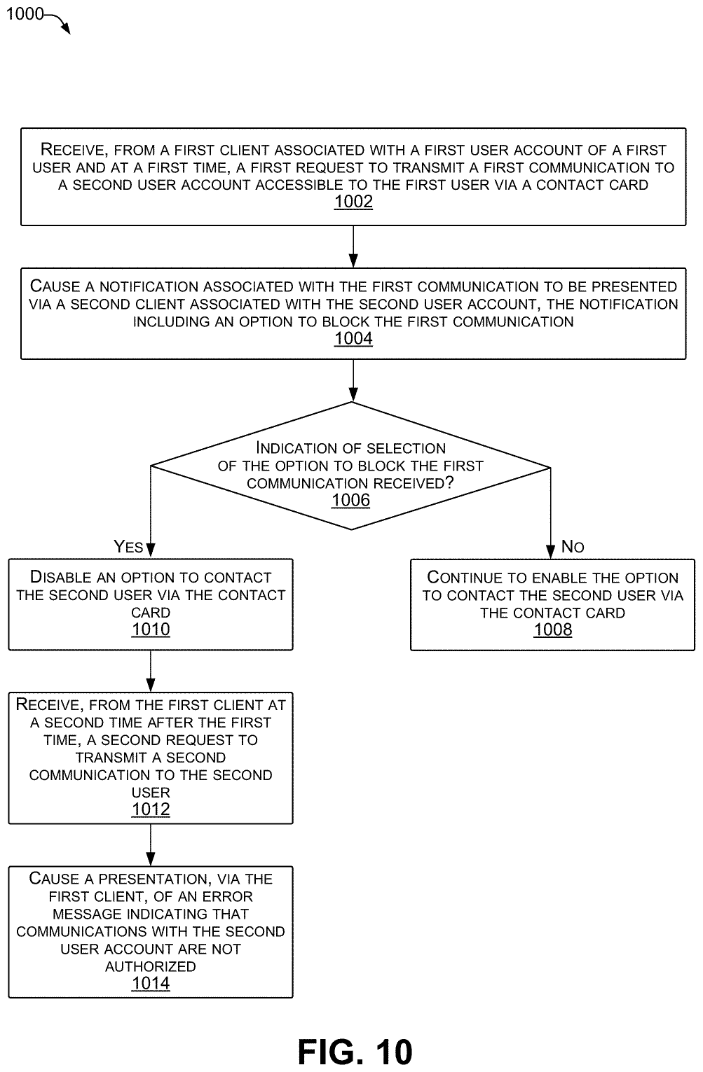

FIG. 10 illustrates an example process 1000 for disabling communications via a contact card in response to receiving a request to block the communications, utilizing the techniques described herein. In some examples, some or all of process 1000 may be performed by one or more components in the system 100. By way of example and not limitation, the communication platform referred to in process 1000 may be representative of a computing device associated with the (communication platform) server(s) 102, the first user computing device referred to in process 1000 may be representative of the user computing device(s) 104. However, the process 1000 is not limited to being performed by the system 100.

At operation 1002, the communication platform receives, from a first client associated with a first user account of a first user and at a first time, a first request to transmit a first communication to a second user account accessible to the first user via a contact card. As discussed above, in various examples, a third user can provide the contact card to the first user, such as in association with another communication. In such examples, in response to receiving an input associated with an identifier or a mention of the second user in the other communication between the first user and the third user, the communication platform can cause a presentation of (e.g., unfurl) the contact card.

In various examples, in response to receiving a selection, by the first user, of the contact card, the communication platform can cause a presentation of a message composer interface (e.g., message composer interface 328, message composer interface 344, message composer interface 440, message composer interface 630, etc.). In some examples, the request to transmit the first communication can be received via the message composer interface, such as by selection of a send message selectable control, such as send message selectable control 334.

At operation 1004, the communication platform causes a notification associated with the first communication to be presented via a second client associated with the second user account, the notification including an option (e.g., selectable control) to block the communication. In various examples, the notification can include an indication that the first user has sent the second communication to the second user. In such examples, the notification can include an indication of an “unread” message. In some examples, the notification can include an indication that the first user requests to connect with the second user. In such examples, the notification can include an indication of a “pending invitation” to connect with the first user, such as in a connect interface.

In various examples, the option to block the communication can include an option to block the first communication. In some examples, the option to block the first communication can include an option to block subsequent communications from the first user. That is, the option to block the first communication can enable the second user to prevent other communications (e.g., messages, calls, etc.) from the first user.

At operation 1006, the communication platform determines whether an indication of selection of the option to block the first communication is received (e.g., selection of the option to block is detected). Based on a determination that the indication of selection of the option to block is not received (“No” at operation 1006), the communication platform, at operation 1008, continues to enable the option to contact the second user via the contact card. In various examples, the communication platform can additionally continue to cause a presentation of the notification via the second client. In some examples, the communication platform can cause the presentation of the notification until a threshold time period associated with the notification has expired (e.g., threshold time passed).

Based on a determination that the indication of selection of the option to block is received (“Yes” at operation 1006), the communication platform, at operation 1010, disables an option to contact the second user via the contact card. That is, the communication platform can disable one or more selectable controls associated with the contact card. In some examples, the communication platform disables a messaging selectable control, such as messaging selectable control 230. In some examples, the communication platform can disable a selectable control associated with storing contact information associated with the second user in a contact list (e.g., directory) associated with the first user.

At operation 1012, the communication platform receives, from the first client at a second time after the first time, a second request to transmit a second communication to the second user. In some examples, the second request can be received via a message composer interface, such as by the first user inputting an identifier or contact information associated with the second user. In some examples, the second request can be received in association with the contact card.

At operation 1014, the communication platform causes a presentation, via the first client, of an error message indicating that communications with the second user account are not authorized. In various examples, the communication platform can determine that the communications are not authorized based on the selection of the option to block the first communication, as described above. In such examples, in response to receiving the indication of selection of the option to block, the communication platform can store an indication that communications from the first user to the second user are not authorized (e.g., not permitted).

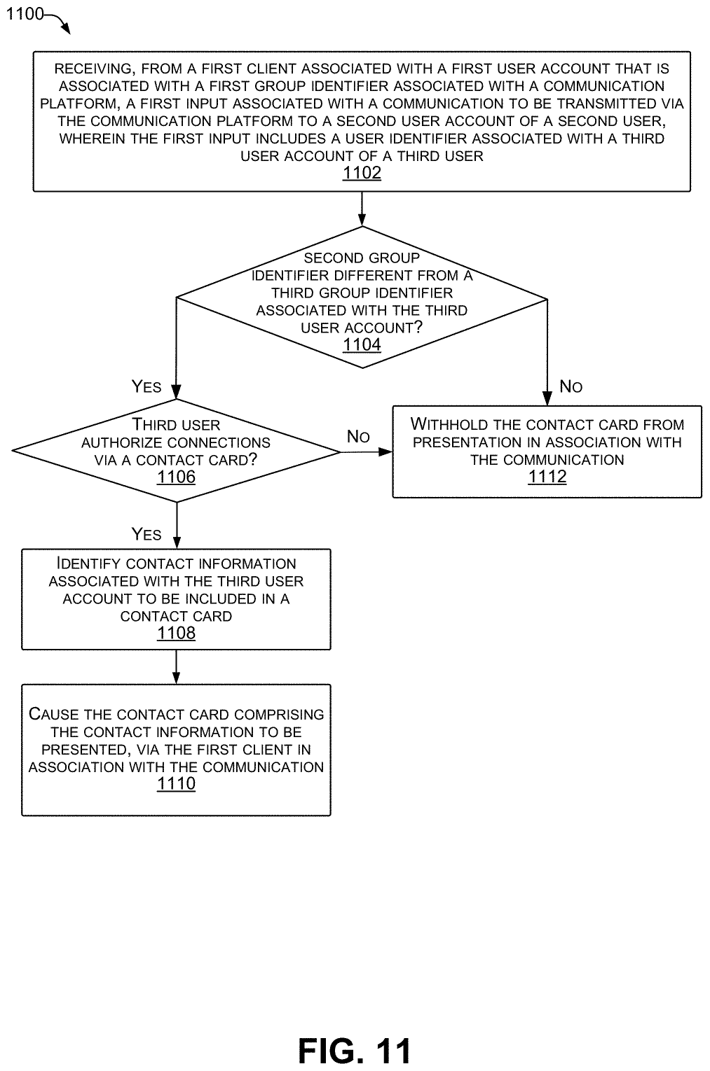

FIG. 11 illustrates an example process 1100 for determining whether to cause a presentation of a contact card of a first user in association with a communication between a second user and a third user, utilizing the techniques described herein. In some examples, some or all of process 1100 may be performed by one or more components in the system 100. By way of example and not limitation, the communication platform referred to in process 1100 may be representative of a computing device associated with the (communication platform) server(s) 102, the first user computing device referred to in process 1100 may be representative of the user computing device(s) 104. However, the process 1100 is not limited to being performed by the system 100.

At operation 1102, the communication platform receives, from a first client associated with a first user account that is associated with a first group identifier associated with a communication platform, a first input associated with a communication to be transmitted via the communication platform to a second user account of a second user, wherein the first input includes a user identifier associated with a third user account of a third user. In at least one example, the user identifier can include a mention of the third user, such as a symbol (e.g., @, $, \hat{ }, #, *, &, etc.) in association with a username, real name, user ID, and/or the like associated with the third user. In at least one example, the mention can include an @mention of the third user. For example, the first user can include @thirduser in the text of the communication. Though this is not intended to be so limiting, and additional or alternative symbols are contemplated herein.

At operation 1104, the communication platform determines whether the second group identifier is different from a third group identifier associated with the third user account. In some examples, different group identifiers can indicate that the second user and the third user are associated with different organizations. In some examples, a determination of a difference between the second group identifier and the third group identifier can include a determination that the difference meets or exceeds a threshold difference between the two group identifiers. The threshold difference can include a threshold number of letters, numbers, symbols, and/or the like associated with the group identifiers that are different from one another. For example, the communication platform can determine that the second group identifier, 1234A, and the third group identifier, 1234B, do not include the threshold difference. For another example, the communication platform can determine that the second group identifier, 1234, and the third group identifier, 1235, do include the threshold difference. Though these are merely illustrative examples and are not intended to be so limiting.

Based on a determination that the second group identifier is different from the third group identifier (“Yes” at operation 1104), the communication platform, at operation 1106, determines whether the third user authorizes connections via a contact card. In some examples, the communication platform can access one or more user preferences and/or organization preferences of an organization associated with the third user (e.g., organization associated with the third group identifier) to determine whether connections via the contact card are authorized. In some examples, an authorization of connections via the contact card can include an authorization for another user to share contact information associated with the third user account.

Based on a determination that the third user (and/or an organization associated therewith) authorizes connections via the contact card the communication platform (“Yes” at operation 1106), the communication platform, at operation 1108, identifies contact information associated with the third user account to be included in the contact card. In some examples, the communication platform can identify the contact information based on one or more user preferences and/or organization preferences of the organization of the third user. In various examples, the communication platform can identify the contact information based on predetermined criteria associated with contact cards. That is, the communication platform can store criteria associated with contact information to include in contact cards, and can identify the contact information of the third user based on the criteria.

At operation 1110, the communication platform causes the contact card comprising the contact card to be presented, via the first client, in association with the communication. In various examples, the communication platform can cause the contact card to be presented (e.g., unfurled) in response to receiving a request to transmit the communication via a virtual space. In such examples, the contact card can be attached to and/or presented in association with the communication in response to receiving the request to transmit the communication via the virtual space. The virtual space can include a direct messaging instance, a communication channel, a thread associated with a communication channel, a workspace, a board, and/or other spaces that enable written communications between the first user and the second user.

In some examples, in response to receiving the request to transmit the communication, the communication platform can cause a presentation of the contact card in association with the communication to all or a portion of the members of the virtual space via which the communication is transmitted. In at least one example, the communication platform can cause the presentation or the contact card in association with the communication to via a second client associated with the second user (e.g., intended recipient of the communication).

Based on a determination that the second group identifier is the same or substantially the same (e.g., within the threshold difference) as the third group identifier (“No” at operation 1104) and/or based on a determination that the third user (and/or an organization associated therewith) does not authorize connections via the contact card the communication platform (“No” at operation 1106), the communication platform, at operation 1112, withholds the contact card from presentation in association with the communication. That is, based on a determination that either the second user and the third user are associated with a same or similar organization or that the third user does not authorize contact sharing, the communication platform withholds the contact card including contact information associated with the third user from presentation in association with the communication.

In some examples, based on a determination to withhold the contact card, the communication platform can cause a presentation of an error message indicating that contact sharing associated with the third user is not authorized. In at least one example, the error message can include an indication of a reason that the contact card is withheld from presentation. Non-limiting examples of reasons that the contact card is withheld can include a determination that the second user and the third user are associated with a same or similar organization, determination that the second user and the third user have previously established a connection (e.g., contact information of the third user stored in association with a contact list or directory associated with the second user, or vice versa), a determination that the third user and/or an organization associated therewith does not authorize contact sharing via contact cards, and/or the like.

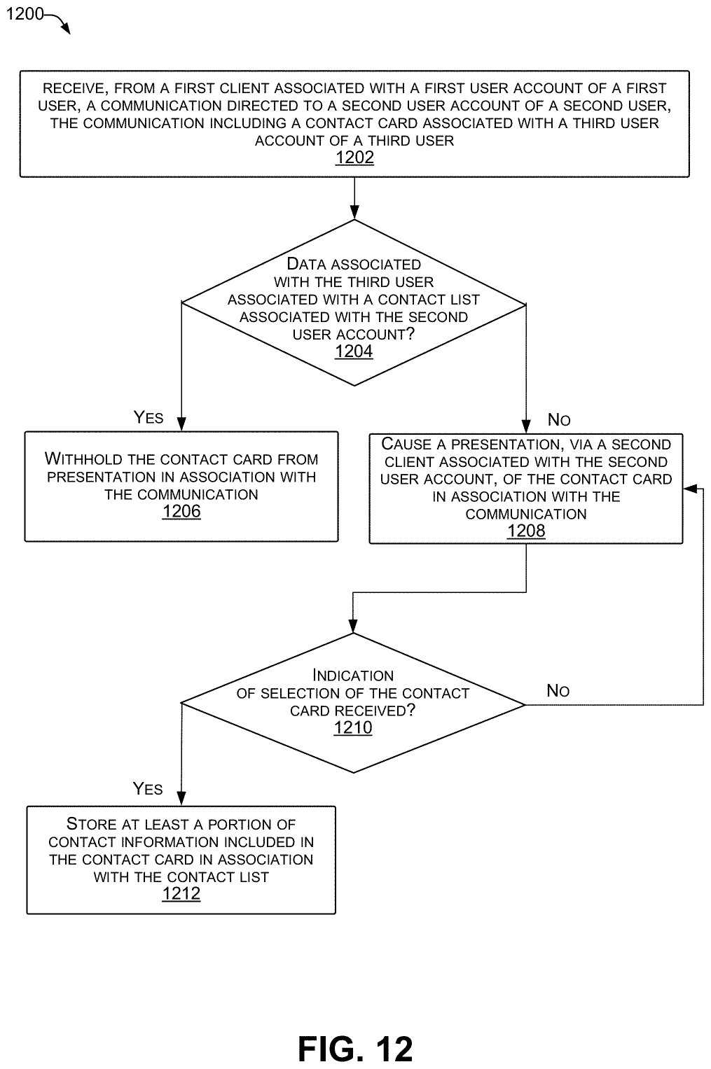

FIG. 12 illustrates an example process 1200 for storing contact information associated with a contact card in a contact list of a user, utilizing the techniques described herein. In some examples, some or all of process 1200 may be performed by one or more components in the system 100. By way of example and not limitation, the communication platform referred to in process 1200 may be representative of a computing device associated with the (communication platform) server(s) 102, the first user computing device referred to in process 1200 may be representative of the user computing device(s) 104. However, the process 1200 is not limited to being performed by the system 100.

At operation 1202, the communication platform receives, from a first client associated with a first user account of a first user, a communication directed to a second user account of a second user, the communication including a contact card associated with a third user account of a third user. In some examples, in response to receiving an input associated with an identifier or a mention of the third user in the communication between the first user and the second user, the communication platform can cause a presentation of (e.g., unfurl) the contact card. In some examples, the communication platform can receive the communication in response to a selection, by the first user, of a send message selectable control, such as send message selectable control 334.

At operation 1204, the communication platform determines whether data associated with the third user account is associated with a contact list associated with the second user account. The data can include contact information associated with the third user account. In some examples, the association of the data with the contact list can represent a previously established connection between the second user account and the third user account. That is, the communication platform can determine, based on an association of the data associated with the third user account with a contact list of the second user account, that the second user and the third user have previously established a connection via the communication platform.

Based on a determination that the data associated with the third user is associated with the contact list associated with the second user (“Yes” at operation 1204), the communication platform, at operation 1206, withholds the contact card from presentation in association with the communication. In some examples, based on a determination to withhold the contact card, the communication platform can cause a presentation of an error message indicating that the second user and the third user have previously established a connection (e.g., contact information of the third user stored in association with a contact list or directory associated with the second user, or vice versa), and that a presentation of the contact card is not necessary.

Based on a determination that the data associated with the third user is not associated with the contact list associated with the second user (“No” at operation 1204), the communication platform, at operation 1208, causes a presentation, via a second client associated with the second user account, of the contact card in association with the communication. In various examples, the communication platform can cause the communication and/or the contact card to be presented to other members of a virtual space via which the communication is transmitted. In some examples, the communication platform can cause the communication and/or the contact card to be presented to the other members regardless of whether the other users are associated with a same or similar organization as, and/or had previously established connections with, the third user. In some examples, the communication platform can identify one or more members of the virtual space that are associated with a same or similar organization as the third user and/or have previously established a connection therewith, and may withhold the contact card from presentation in association with instances of the communication that are presented to the one or more members.

At operation 1210, the communication platform determines whether an indication of selection (e.g., a selection) of the contact card is received via the second client. Based on a determination that the indication of selection of the contact card is not received (“No” at operation 1210), the communication platform causes the presentation of the contact card in association with the communication, as described above with respect to operation 1208. Based on a determination that the indication of selection of the contact card is received (“Yes” at operation 1210), the communication platform, at operation 1212, stores at least a portion of the contact information included in the contact card in association with the contact list associated with the second user. In at least one example, the at least the portion of the contact information can include data that can enable the second user to generate and send an invitation to connect (e.g., another communication) to the third user account.

### Example Clauses

A: A method implemented at least in part by one or more computing devices of a communication platform, the method comprising: receiving, from a first client associated with a first user account of a first user associated with the communication platform, a contact card associated with a second user account of a second user, wherein the contact card is presented in association with a first communication transmitted from a third user account of a third user to at least the first user account; in response to detecting selection of the contact card associated with the second user, causing a message composer interface to be presented on a first display of the first client, wherein the message composer interface comprises a second communication to be transmitted to the second user account; receiving, from the first client and via the message composer interface, a request to transmit the second communication to the second user account via the communication platform; and causing a notification associated with the second communication to be presented on a second display of a second client associated with the second user account and via a second interface.

B: The method of paragraph A, further comprising: receiving, from the second client and via the second interface, an indication of selection of a selectable option to accept the second communication; and generating a messaging instance between the first user account and the second user account, wherein the messaging instance enables communications to be transmitted between the first user account and the second user account.

C: The method of either paragraph A or paragraph B, further comprising: receiving, from the second client and via the second interface, a selection of an indication to ignore the second communication; and removing the notification from the second interface associated with the second client.

D: The method of any one of paragraphs A-C, further comprising: receiving, from the second client and via the second interface, a selection of an indication to block the second communication; and in response to receiving the indication to block the second communication, disabling an option to contact the second user.

E: The method of any one of paragraphs A-D, wherein the indication to block the second communication is received at a first time, the method further comprising: receiving, at a second time and via a second message composer interface of the first client, a request to transmit a third communication to the second user account; and causing a presentation, via the second message composer interface, of an error message.

F: The method of any one of paragraphs A-E, further comprising adding the second user to a contact list associated with the first user account.

G: The method of any one of paragraphs A-F, wherein the contact card comprises at least one of: a name associated with the second user; an avatar associated with the second user; an organization associated with the second user; an email address associated with the second user; or a link to enable a communication to be sent to the second user.

H: The method of any one of paragraphs A-G, further comprising: receiving at least one of a user preference or an organizational preference associated with contact information to include in the contact card; identifying the contact information associated with the second user based at least in part on the at least one of the user preference or the organizational preference; and causing a presentation of the contact information in association with the contact card.

I: A system comprising: one or more processors; and one or more non-transitory computer readable media storing instructions that, when executed, cause the system to: receive, from a first client associated with a first user account of a first user associated with a communication platform, a contact card associated with a second user account of a second user, wherein the contact card is presented in association with a first communication transmitted from a third user account of a third user to at least the first user account; in response to detecting selection of the contact card associated with the second user, cause a message composer interface to be presented on a first display of the first client, wherein the message composer interface comprises a second communication to be transmitted to the second user account; receive, from the first client and via the message composer interface, a request to transmit the second communication to the second user account via the communication platform; and cause a notification associated with the second communication to be presented on a second display of a second client associated with the second user account and via a second interface.

J: The system of paragraph I, wherein the instructions further cause the system to: receive, from the second client and via the second interface, an indication of selection of a selectable option to accept the second communication; and generate a messaging instance between the first user account and the second user account, wherein the messaging instance enables communications to be transmitted between the first user account and the second user account.

K: The system of either paragraph I or paragraph J, wherein the instructions further cause the system to: receive, from the second client and via the second interface, a selection of an indication to ignore the second communication; and remove the notification from the second interface associated with the second client.

L: The system of any one of paragraphs I-K, wherein the instructions further cause the system to: receive, from the second client and via the second interface, a selection of an indication to block the second communication; and in response to receiving the indication to block the second communication, disable an option to contact the second user.

M: The system of any one of paragraphs I-L, wherein the indication to block the second communication is received at a first time and the instructions further cause the system to: receive, at a second time and via a second message composer interface of the first client, a request to transmit a third communication to the second user account; and cause a presentation, via the second message composer interface, of an error message.

N: The system of any one of paragraphs I-M, wherein the instructions further cause the system to add the second user to a contact list associated with the first user account.

O: The system of any one of paragraphs I-N, wherein the contact card comprises at least one of: a name associated with the second user; an avatar associated with the second user; an organization associated with the second user; an email address associated with the second user; or a link to enable a communication to be sent to the second user.

P: The system of any one of paragraphs I-O, wherein the instructions further cause the system to: receive at least one of a user preference or an organizational preference associated with contact information to include in the contact card; identify the contact information associated with the second user based at least in part on the at least one of the user preference or the organizational preference; and cause a presentation of the contact information in association with the contact card.

Q: One or more non-transitory computer readable media storing instructions that, when executed, cause one or more processors to: receive, from a first client associated with a first user account of a first user associated with a communication platform, a contact card associated with a second user account of a second user, wherein the contact card is presented in association with a first communication transmitted from a third user account of a third user to at least the first user account; in response to detecting selection of the contact card associated with the second user, cause a message composer interface to be presented on a first display of the first client, wherein the message composer interface comprises a second communication to be transmitted to the second user account; receive, from the first client and via the message composer interface, a request to transmit the second communication to the second user account via the communication platform; and cause a notification associated with the second communication to be presented on a second display of a second client associated with the second user account and via a second interface.

R: The one or more non-transitory computer readable media of paragraph Q, wherein the instructions further cause the one or more processors to: receive, from the second client and via the second interface, an indication of selection of a selectable option to accept the second communication; and generate a messaging instance between the first user account and the second user account, wherein the messaging instance enables communications to be transmitted between the first user account and the second user account.

S: The one or more non-transitory computer readable media of either paragraph Q or paragraph R, wherein the instructions further cause the one or more processors to: receive, from the second client and via the second interface, a selection of an indication to ignore the second communication; and remove the notification from the second interface associated with the second client.

T: The one or more non-transitory computer readable media of any one of paragraphs Q-S, wherein the instructions further cause the one or more processors to: receive, from the second client and via the second interface, a selection of an indication to block the second communication; and in response to receiving the indication to block the second communication, disable an option to contact the second user.

While the example clauses described above are described with respect to one particular implementation, it should be understood that, in the context of this document, the content of the example clauses may also be implemented via a method, device, system, a computer-readable medium, and/or another implementation.

### Conclusion

While one or more examples of the techniques described herein have been described, various alterations, additions, permutations and equivalents thereof are included within the scope of the techniques described herein.

In the description of examples, reference is made to the accompanying drawings that form a part hereof, which show by way of illustration specific examples of the claimed subject matter. It is to be understood that other examples can be used and that changes or alterations, such as structural changes, can be made. Such examples, changes or alterations are not necessarily departures from the scope with respect to the intended claimed subject matter. While the steps herein can be presented in a certain order, in some cases the ordering can be changed so that certain inputs are provided at different times or in a different order without changing the function of the systems and methods described. The disclosed procedures could also be executed in different orders. Additionally, various computations that are herein need not be performed in the order disclosed, and other examples using alternative orderings of the computations could be readily implemented. In addition to being reordered, the computations could also be decomposed into sub-computations with the same results.

1. A method implemented at least in part by one or more computing devices of a communication platform, the method comprising:
receiving, from a first client associated with a first user account of a first user associated with the communication platform, a contact card associated with a second user account of a second user, wherein the contact card is presented in association with a first communication transmitted from a third user account of a third user to at least the first user account via a first communication channel of the communication platform, wherein the first communication channel is associated with one or more first permissions that authorize a first set of users, including the first user and the third user, to access the first communication channel;
in response to detecting a selection associated with the contact card associated with the second user, causing a message composer interface to be presented on a first display of the first client, wherein the message composer interface comprises a second communication to be transmitted to the second user account via a second communication channel, different than the first communication channel, of the communication platform, wherein the second communication channel is associated with one or more second permissions that authorize a second set of users, different than the first set of users and including the first user and the second user, to access the second communication channel;
receiving, from the first client and via the message composer interface, a request to transmit the second communication to the second user account via the second communication channel; and
causing a notification associated with the second communication to be presented on a second display of a second client associated with the second user account and via a second interface associated with the second communication channel.

2. The method of claim 1, further comprising:
receiving, from the second client and via the second interface, an indication of a second selection of a selectable option to accept the second communication; and
generating a messaging instance between the first user account and the second user account, wherein the messaging instance enables communications to be transmitted between the first user account and the second user account.

3. The method of claim 1, further comprising:
receiving, from the second client and via the second interface, a second selection of an indication to ignore the second communication; and
removing the notification from the second interface associated with the second client.

4. The method of claim 1, further comprising:
receiving, from the second client and via the second interface, a second selection of an indication to block the second communication; and
in response to receiving the indication to block the second communication, disabling an option to contact the second user.

5. The method of claim 4, wherein the indication to block the second communication is received at a first time, the method further comprising:
receiving, at a second time and via a second message composer interface of the first client, a request to transmit a third communication to the second user account; and
causing a presentation, via the second message composer interface, of an error message.

6. (canceled)

7. (canceled)

8. The method of claim 1, further comprising:
receiving at least one of a user preference or an organizational preference associated with contact information to include in the contact card;
identifying the contact information associated with the second user based at least in part on the at least one of the user preference or the organizational preference; and
causing a presentation of the contact information in association with the contact card.

9. A system comprising:
one or more processors; and
one or more non-transitory computer readable media storing instructions that, when executed, cause the system to:
receive, from a first client associated with a first user account of a first user associated with a communication platform, a contact card associated with a second user account of a second user, wherein the contact card is presented in association with a first communication transmitted from a third user account of a third user to at least the first user account via a first communication channel of the communication platform, wherein the first communication channel is associated with one or more first permissions that authorize a first set of users, including the first user and the third user, to access the first communication channel;
in response to detecting a selection associated with the contact card associated with the second user, cause a message composer interface to be presented on a first display of the first client, wherein the message composer interface comprises a second communication to be transmitted to the second user account via a second communication channel, different than the first communication channel, of the communication platform, wherein the second communication channel is associated with one or more second permissions that authorize a second set of users, different than the first set of users and including the first user and the second user, to access the second communication channel;
receive, from the first client and via the message composer interface, a request to transmit the second communication to the second user account via the second communication channel; and
cause a notification associated with the second communication to be presented on a second display of a second client associated with the second user account and via a second interface associated with the second communication channel.

10. The system of claim 9, wherein the instructions further cause the system to:
receive, from the second client and via the second interface, an indication of a second selection of a selectable option to accept the second communication; and
generate a messaging instance between the first user account and the second user account, wherein the messaging instance enables communications to be transmitted between the first user account and the second user account.

11. The system of claim 9, wherein the instructions further cause the system to:
receive, from the second client and via the second interface, a second selection of an indication to ignore the second communication; and
remove the notification from the second interface associated with the second client.

12. The system of claim 9, wherein the instructions further cause the system to:
receive, from the second client and via the second interface, a second selection of an indication to block the second communication; and
in response to receiving the indication to block the second communication, disable an option to contact the second user.

13. The system of claim 12, wherein the indication to block the second communication is received at a first time and the instructions further cause the system to:
receive, at a second time and via a second message composer interface of the first client, a request to transmit a third communication to the second user account; and
cause a presentation, via the second message composer interface, of an error message.

14. The system of claim 9, wherein the instructions further cause the system to add the second user to a contact list associated with the first user account.

15. The system of claim 9, wherein the contact card comprises at least one of:
a name associated with the second user;
an avatar associated with the second user;
an organization associated with the second user;
an email address associated with the second user; or
a link to enable a communication to be sent to the second user.

16. The system of claim 9, wherein the instructions further cause the system to:
receive at least one of a user preference or an organizational preference associated with contact information to include in the contact card;
identify the contact information associated with the second user based at least in part on the at least one of the user preference or the organizational preference; and
cause a presentation of the contact information in association with the contact card.

17. One or more non-transitory computer readable media storing instructions that, when executed, cause one or more processors to:
receive, from a first client associated with a first user account of a first user associated with a communication platform, a contact card associated with a second user account of a second user, wherein the contact card is presented in association with a first communication transmitted from a third user account of a third user to at least the first user account via a first communication channel of the communication platform, wherein the first communication channel is associated with one or more first permissions that authorize a first set of users, including the first user and the third user, to access the first communication channel;
in response to detecting a selection associated with the contact card associated with the second user, cause a message composer interface to be presented on a first display of the first client, wherein the message composer interface comprises a second communication to be transmitted to the second user account via a second communication channel, different than the first communication channel, of the communication platform, wherein the second communication channel is associated with one or more second permissions that authorize a second set of users, different than the first set of users and including the first user and the second user, to access the second communication channel;
receive, from the first client and via the message composer interface, a request to transmit the second communication to the second user account via the second communication channel; and
cause a notification associated with the second communication to be presented on a second display of a second client associated with the second user account and via a second interface associated with the second communication channel.

18. The one or more non-transitory computer readable media of claim 17, wherein the instructions further cause the one or more processors to:
receive, from the second client and via the second interface, an indication of a second selection of a selectable option to accept the second communication; and
generate a messaging instance between the first user account and the second user account, wherein the messaging instance enables communications to be transmitted between the first user account and the second user account.

19. The one or more non-transitory computer readable media of claim 17, wherein the instructions further cause the one or more processors to:
receive, from the second client and via the second interface, a second selection of an indication to ignore the second communication; and
remove the notification from the second interface associated with the second client.

20. The one or more non-transitory computer readable media of claim 17, wherein the instructions further cause the one or more processors to:
receive, from the second client and via the second interface, a second selection of an indication to block the second communication; and
in response to receiving the indication to block the second communication, disable an option to contact the second user.

21. The method of claim 1, further comprising:
determining whether a contact list associated with the first user includes the second user;
determining whether the first user and the second user have previously communicated via the communication platform; and
based at least in part on a first determination that the contact list does not include the second user and a second determination that the first user and the second user have not previously communicated via the communication platform, causing the notification associated with the second communication to be presented on the second display of the second client.

22. The method of claim 1, further comprising:
determining whether at least one of the second user or an organization associated with the second user allows contact sharing via the communication platform; and
based at least in part on a determination that the at least one of the second user or the organization allows the contact sharing via the communication platform, causing the notification associated with the second communication to be presented on the second display of the second client.
